(19) United States
(12) Patent Application Publication
(10) Pub. No.: US 2006/0155619 A1
(43) Pub. Date: Jul. 13, 2006

(54) Identification system

(76) Inventors: Maxwell Earl Rhiando, Camberley (GB); Neil Maxwell Rhiando, Cemberley (GB)

Correspondence Address: NIXON & VANDERHYE, PC, 901 NORTH GLEBE ROAD, 11TH FLOOR, ARLINGTON, VA, 22203, US

(21) Appl. No.: 10/529,235

(22) PCT Filed: Sep. 29, 2003
(86) PCT No.: PCT/GB03/04225

§ 371 Date: Nov. 10, 2005

(30) Foreign Application Priority Data
Sep. 27, 2002 (GB) 0222517.5

(51) Int. Cl. G06Q 40/00

(52) U.S. Cl. 705/35

(57) ABSTRACT

A card-based identification system includes one or more terminals (40) which can communicate with a database in a server. Each terminal can receive a card and includes computing means which can generate an impersonal card identifier. The terminal includes an input device (20) which can be operated by a user to input a group of characters known only to a user. The input device includes a plurality of zones (27) each of which is operable by a user to input a character. The zones are arranged so that character with which each zone is associated changes randomly each time a card is received. Also the zones (27) are arranged so that characters with which they are associated are visible only within a restricted viewing angle. The terminal creates an impersonal user identifier from the input characters and these are transmitted with the impersonal card identifier to the database for recording or comparison with stored data. The transmitted data is preferably in numeric form.

The invention relates to an identification system for originating a set of impersonal identifiers at a computer terminal and recording the set of impersonal identifiers at a card-type server to execute an anonymous registration before a security card or payment card is issued, and separately, for generating a set of impersonal identifiers at a computer terminal and matching the set of impersonal identifiers at the card-type server to execute an anonymous validation after the security card or payment card is issued. Each computer terminal is installed at a separate location with a designated two-way communication identifier.

The word “card” is hereinafter used in the description to include any kind of document such as a licence, passport or identity card for use at an airport check-in, and such as a voucher, ticket or credit card for use at a retail check-out. The identification system therefore has diverse uses in the public sectors for identification purposes and in the private sectors for transaction purposes in any country to provide an identification system for universal use with point-of-origin identification.

The expression “counterpart card” is hereinafter used in the description to include any kind of document such as an application form or membership form for point-of-origin registration and may include personal information for storing personal records at the data centre of a card-issuer only.

The identification system is intended for card-issuers such as government agencies and commercial companies in every country to provide a global platform for creating and locating card-type records in national databases without reference to individual persons, in that the card-type records are impersonal for anonymous registration and anonymous validation. As a consequence, all cards are segregated into card groups and each card group consists of discrete card-types, which can display the name and emblem of different card-issuers to distinguish the difference between the discrete card-types in each card group. For example, one card-type displays the name of one card-issuer.

Accordingly, the individual cards for a discrete card-type are produced with the same card-type code to identify the card-issuer and country of origin for a computer terminal to receive and identify individual cards in the unissued state or issued state for the discrete card-type. The number of individual cards for each discrete card-type and therefore the number of card-type records in the database of each card-type server extend to an order of magnitude.

Security cards for identification use and payment cards for transaction use are known and are described in prior art as cards with personal identifiers which are referred to herein as the personal card category, and cards without personal identifiers which are referred to herein as the impersonal card category.

Personal card category: Personal cards are described in well established prior art for at least 40-years and it is acknowledged that personal cards are used for executing transactions at a terminal using personal identifiers such as a signature, password or personal identity number (PIN) which are known to the authorised user.

The main advantage of this card category is that personal cards have been in use for at least 40-years and are therefore accepted as a payment system for the purchase of products and services in retail outlets worldwide.

The main disadvantage of this card category is that the personal identifiers of the cardholder are displayed or carried on the card for counterfeiters and fraudsters to replicate and reproduce to obtain goods and services of value by deception in a store or by phone. Personal cards display personal identifiers such as a photograph, signature, fingerprint, name and account number of the cardholder. Furthermore, this card category includes personal details on magnetic strips (swipe cards) or in electronic chips (smart cards) which can be erased, altered or copied for a fraudster to use the identity or account of another person.

Impersonal card cateporv: Impersonal cards are described in the International Application Number WO99/36889 which relates to a transaction system and it is acknowledged that impersonal cards are used for executing transactions at a terminal using an impersonal card-identifier and impersonal user-identifier for a card-type registration and card-type validation. One aspect of this application describes a terminal using a reciprocating printer for writing a card-identifier and using a biometric sensor to capture a live-scan image of a fingerprint for the user-identifier.

The main advantage of this card category is that no personal identifiers of the cardholder are displayed or carried on the card, therefore no reference to an individual person exists on an impersonal card for fraudulent use by an unauthorised person. Furthermore, this card category incorporates thermal panels instead of magnetic strips and electronic chips for printing permanent information thereon which cannot be altered or erased.

The main disadvantage of this card category is that the terminals described in the prior art for impersonal cards cannot be used for personal cards. It is therefore desirable to use the terminals in the present invention for both card categories by adapting personal cards for impersonal use without reference to the personal identifiers displayed or carried on personal cards. The identification system therefore includes integral means for discrete card-types which include or exclude personal identifiers as one of the preferred embodiments.

The present invention relates to an identification system for discrete card-types with integral means to receive and identify individual cards for a discrete card-type in any computer terminal to perform the following two primary functions:

(A) to originate a set of impersonal identifiers for an anonymous registration.

(B) to generate a set of impersonal identifiers for an anonymous validation.

The computer terminal may vary in type and size to perform the two primary functions (A+B) or perform one of the primary functions (A) or (B). Consequently, at least three types of computer terminal may be used at the same time to perform the said primary functions for discrete card-types with network compatibility. Two types of computer terminal are herein described, by way of example, with different modes of operation by selecting a combination of devices with integral means for operating in an arranged order to perform the primary functions (A+B) and the primary function (B).

The computer terminal which performs the primary functions (A+B) incorporates the following referenced device operations which are preferred embodiments described in the present invention.

A1) Computer means to originate an impersonal card-identifier and encrypt into a registration code and write encoded data and ancillary data for a card in the unissued state.

A2) Guide means to receive and identify a card in the unissued state, capture a first image on the card to decode and decrypt in a computer, and receive encoded data for printing on the card to capture a second image to decode and decrypt in a computer, and write discrete data carried and concealed within the card.

A3) Display means to output selective commands from the computer to operate the terminal.

A4) Keyboard means to input selective commands to the computer to operate the terminal.

A5) Sensor means to receive concealed data for input to the computer to encrypt and originate an impersonal user-identifier.

A6) Modern means to transmit impersonal identifiers and receive instruction identifiers for a card in the unissued state.

B1) Computer means to decode a symbology and decrypt a registration code to generate an impersonal card-identifier for a card in the issued state.

B2) Guide means to receive and identify a card in the issued state, capture a first image on the card to decode and decrypt in a computer, and read discrete data carried and concealed within the card.

B3) Display means to output selective commands from the computer to operate the terminal.

B4) Keyboard means to input selective commands to the computer to operate the terminal.

B5) Sensor means to receive concealed data for input to the computer to encrypt and generate an impersonal user-identifier.

B6) Modem means to transmit impersonal identifiers and receive instruction identifiers for a card in the issued state.

The computer terminal which performs the primary function (B) incorporates the following referenced device operations which are also preferred embodiments described in the present invention. In this example, three modes of operation have been selected for this type of computer terminal described herein.

B1) Computer means to decode a symbology and decrypt a registration code to generate an impersonal card-identifier for a card in the issued state.

B2) Guide means to receive and identify a card in the issued state, capture a first image on the card to decode and decrypt in a computer, and read discrete data carried and concealed within the card.

B5) Sensor means to receive concealed data for input to the computer to encrypt and generate an impersonal user-identifier.

The present invention can include an identification system for discrete card-types with network compatibility between at least one computer terminal and at least one card-type server, using a telecommunications infrastructure such as a public or private telephone network for routing each set of impersonal identifiers including a two-way communication identifier to identify a terminal location and a server location and address each set of impersonal identifiers for a card-type, to create a card-type record or locate a card-type record in the database of the same card-type server for the same card-issuer.

The present invention can use sets of numeric data for the sequence groups numbered 01 to 06 for a computer terminal 80 and using sets of numeric data for the sequence groups 07 to 10 for a computer terminal 140 and host computer 147, wherein each sequence group is a preferred embodiment to describe a method of performing the primary functions (A) and (B) in conjunction with the said device operations A1 to A6 and B1 to B6.

It will be understood that the described examples for each sequence group consists of numeric combinations, which are divided into numeric groups to form numeric constants for recording an original set of numeric data in a card-type server for an anonymous registration and for matching a duplicate set of numeric data in a card-type server for an anonymous validation. It will be further understood that it is impossible to decipher a numeric combination, the arrangement of numerals are not message data. It is simply a number (E.G. 72-digits) and each digit has a concealed order and value. A numeric combination is herein defined as a constant set of numeric data for recording or matching a set of impersonal identifiers in a card-type server without reference to an individual person.

The present invention is therefore dedicated to the construction of a set of numeric data to perform the primary functions (A) or (B) characterised in that the computer terminals and card-type servers transmit and receive impersonal information in numeric form and not in message form for the two-way routing of numeric data from any terminal location to any server location without reference to an individual person.

Accordingly, a first aspect of the present invention comprises an identification system to originate a set of impersonal identifiers for an unissued card-type in a computer terminal and for recording at a card-type server, wherein the system comprises;

a) a terminal which incorporates a guide to receive and identify a card in the unissued state, and to capture a first image for input to a computer to decode and decrypt, and for the computer to originate an impersonal card-identifier and encrypt into a registration code for encoding and printing on the card, and to capture a second image on the card for input to the computer to decode and decrypt, and

b) the terminal incorporates a sensor with touch zones for illuminating an arrangement of segments in each touch zone to display within a restricted viewing angle a random order of characters for a user to enter a concealed group of characters in a selected order for input to the computer to encrypt and originate an impersonal user-identifier in the terminal, and

c) the terminal incorporates a modem to transmit a set of impersonal identifiers to create a card-type record in the database of a card-type server for recording the set of impersonal identifiers to sanction an anonymous registration, and to receive a set of instruction identifiers at the terminal to accept the card and user.

A second aspect of the present invention comprises an identification system to generate a set of impersonal identifiers for an issued card-type in a computer terminal and for matching at a card-type server, wherein the system comprises;

a) a terminal which incorporates a guide to receive and identify a card in the issued state, and to capture a first image on the card for input to a computer to decode and decrypt to generate an impersonal card-identifier in the terminal, and

b) the terminal incorporates a sensor with touch zones for illuminating an arrangement of segments in each touch zone to display within a restrictive viewing angle a random order of characters for a user to enter a concealed group of characters in a selected order for input to the computer to encrypt and generate an impersonal user-identifier in the terminal, and

c) the terminal incorporates a modem to transmit a set of impersonal identifiers to locate a card-type record in the database of a card-type server for matching the set of impersonal identifiers to sanction an anonymous validation, and to receive a set of instruction identifiers at the terminal to accept the card and the user.

A third aspect of the present invention comprises an identification system in which a computer terminal communicates with an external camera to receive discrete data when an unissued card-type is inserted in said terminal, and to originate a set of impersonal identifiers for an unissued card-type in the said terminal and for recording at a card-type server, wherein the system comprises:

a) a terminal which incorporates a guide to receive and identify an impersonal card in the unissued state, and to capture a first image on the card for input to a computer to decode and decrypt, and for the computer to originate an impersonal card-identifier and encrypt into a registration code for encoding and printing on the card, and to capture a second image on the card for input to the computer to decode and decrypt, and to energise an integrated circuit concealed in the card for writing the said discrete data to the integrated circuit, and

b) the terminal incorporates a sensor with touch zones for illuminating an arrangement of segments in each touch zone to display within a restricted viewing angle a random order of numerals for a user to enter a concealed group of numerals in a selected order for input to the computer to encrypt and originate an impersonal user-identifier in the terminal, and

c) the terminal incorporates a modem to transmit a set of impersonal identifiers to create a card-type record in the database of a card-type server for recording the set of impersonal identifiers to sanction an anonymous registration, and to receive a set of instruction identifiers at the terminal to accept the card and user.

A fourth aspect of the present invention comprises an identification system in which a computer terminal communicates with an external screen to display discrete data when an issued card-type is inserted in said terminal, and to generate a set of impersonal identifiers for the issued card-type in said terminal and for matching at a card-type server, wherein the system comprises:

a) a terminal which incorporates a guide to receive and identify an impersonal card in the issued state, and to capture a first image on the card for input to a computer to decode and decrypt to generate an impersonal card-identifier in the terminal, and to energise an integrated circuit concealed in the card for reading the said discrete data on the integrated circuit, and

b) the terminal incorporates a sensor with touch zones for illuminating an arrangement of segments in each touch zone to display within a restrictive viewing angle a random order of numerals for a user to enter a concealed group of numerals in a selected order for input to the computer to encrypt and generate an impersonal user-identifier in the terminal, and

c) the terminal incorporates a modem to transmit a set of impersonal identifiers to locate a card-type record in the database of a card-type server for matching the set of impersonal identifiers to sanction an anonymous validation, and to receive a set of instruction identifiers at the terminal to accept the card and user

A fifth aspect of the present invention comprises an identification system for generating a set of impersonal identifiers for an issued card-type in a computer terminal connected to a host computer for matching at a card-type server, wherein the system comprises;

a) a terminal which incorporates a guide to receive and identify an impersonal card in the issued state, and to capture a first image on the card for input to a computer to decode and decrypt to generate an impersonal card-identifier in the terminal, and

b) the terminal incorporates a sensor with touch zones for illuminating an arrangement of segments in each touch zone to display within a restrictive viewing angle a random order of characters for a user to enter a concealed group of characters in a selected order for input to the computer to encrypt and generate an impersonal user-identifier in the terminal, and

c) the terminal transfers the impersonal card-identifier and impersonal user-identifier to a host computer, and

d) the host computer incorporates a modem to transmit a set of impersonal identifiers to locate a card-type record in the database of a card-type server for matching the set of impersonal identifiers to sanction an anonymous validation, and to receive a set of instruction identifiers at the host computer to accept the card and the user.

A sixth aspect of the present invention comprises an identification system in which a network of computer terminals and a network of card-type servers form separate communication networks for discrete card-types, and wherein each network includes integral means for originating impersonal identifiers at any computer terminal and recording impersonal identifiers at the card-type server, and wherein the integral means for originating and recording a set of impersonal identifiers for an unissued card-type comprises;

a) means to receive and identify a card-type in the unissued state in a terminal;

b) means to write discrete data to an integrated circuit concealed within the card in the terminal;

c) means to originate an impersonal card-identifier for the card in the terminal;

d) means to originate an encrypted registration code for encoding and printing on the card in the terminal;

e) means to input a group of numerals and originate an impersonal user-identifier for the card in the terminal;

f) means to transmit a set of impersonal identifiers for the card-type to a card-type server;

g) means to create a card-type record in the database of the card-type server for recording the set of impersonal identifiers to sanction the anonymous registration, and

g) means to transmit a set of instruction identifiers to the terminal to accept the card and the user.

A seventh aspect of the present invention comprises an identification system in which a network of computer terminals and a network of card-type servers form separate communication networks for discrete card-types, and wherein each network includes integral means for generating impersonal identifiers at any computer terminal and matching impersonal identifiers at the card-type server, and wherein the integral means for generating and matching a set of impersonal identifiers for an issued card-type comprises;

a) means to receive and identify a card-type in the issued state in a terminal;

b) means to read discrete data on an integrated circuit concealed within the card in the terminal;

c) means to decode and decrypt a registration code on the card to generate an impersonal card-identifier in the terminal;

d) means to input a group of numerals and generate an impersonal user-identifier for the card in the terminal;

e) means to transmit a set of impersonal identifiers for the card-type to a card-type server;

f) means to locate a card-type record in the database of the card-type server for matching the set of impersonal identifiers to sanction the anonymous validation, and

g) means to transmit a set of instruction identifiers to the terminal to accept the card and the user

An eighth aspect of the present invention comprises an identification system, wherein a security centre transmits a two-way communication identifier for each terminal location and each server location to a router centre to provide network interconnection and to download the communication identifiers together with encryption codes to each computer terminal and each card-type server for routing encrypted impersonal identifiers and instruction identifiers between the designated locations, and for the security centre to communicate through the router centre for monitoring and up-grading each computer terminal at its designated location.

A ninth aspect of the present invention comprises an identification system in which each set of impersonal identifiers and each set of instruction identifiers for a discrete card-type includes a two-way communication identifier to identify the terminal location and server location, and address each set of impersonal identifiers and instruction identifiers to create a card-type record in the database of a card-type server for anonymous registration at a data centre, or to locate a card-type record in the database of the same card-type for anonymous validation at the data centre.

A tenth aspect of the present invention comprises an identification system with separate data centres to provide demarcation and anonymity for the transfer of compiled data from a data centre with impersonal records to a data centre with personal records, wherein the data centre with impersonal records includes a card-type server for matching a set of impersonal identifiers in a card-type record to compile data to validate an identification or transaction at the data centre, and transfer the compiled data to the data centre of a discrete card-issuer with personal records, the compiled data is impersonal and includes a reference number and activity record for the card-issuer to enter the compiled data in a personal record with the same reference number.

The present invention will now be described, by way of example, with reference to the accompanying diagrammatic drawings, in which:

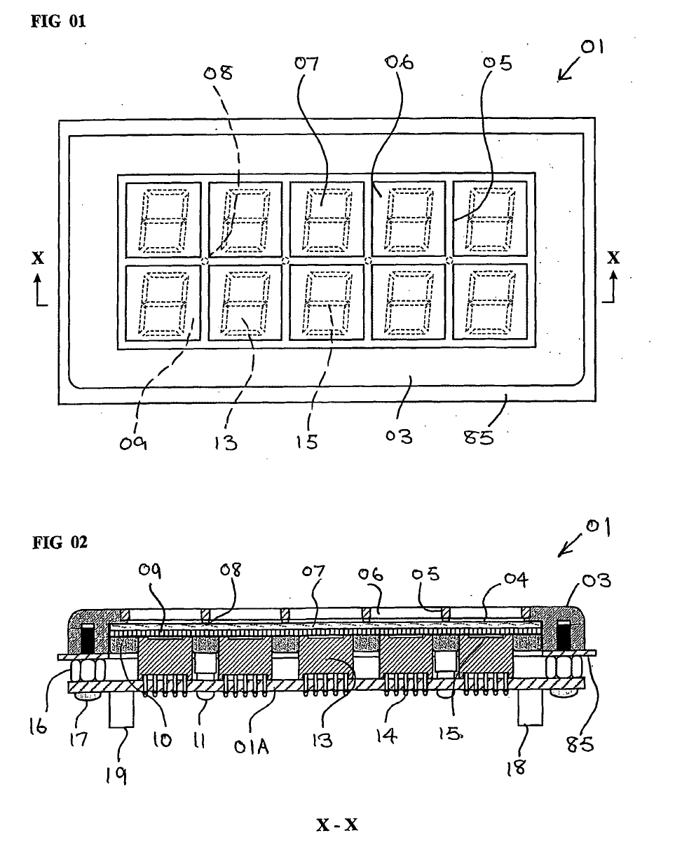

FIG. 01 shows a plan view of a sensor device with ten discrete touch zones for selecting a group of illuminated numerals in each touch zone.

FIG. 02 shows a side elevation of view X-X in cross section, of the sensor device in FIG. 01.

FIG. 03 shows a plan view variant of the sensor device in FIG. 01 with nine discrete touch zones.

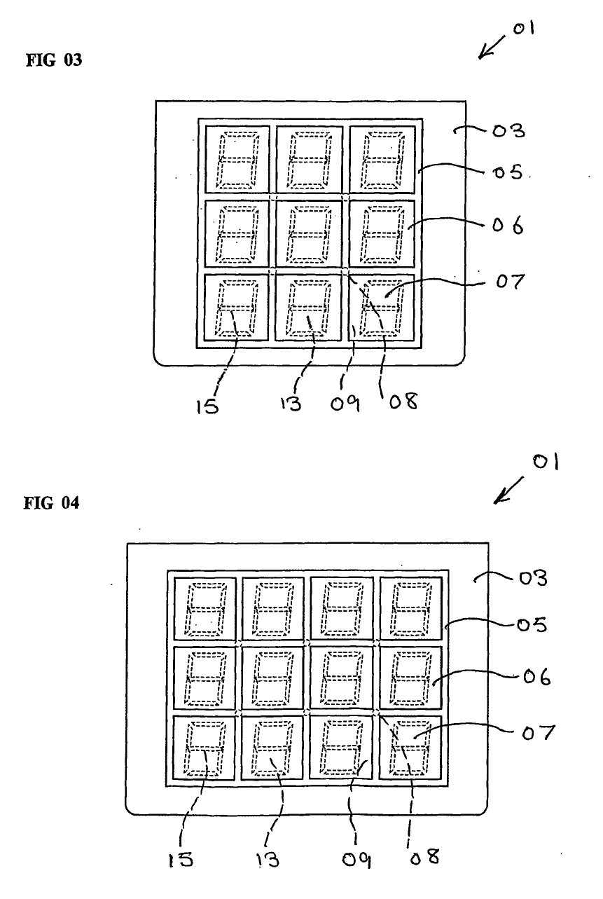

FIG. 04 shows another plan view variant of the sensor device in FIG. 01 with twelve discrete touch zones.

FIG. 05 shows a plan view of another sensor device with a touch screen and liquid crystal display for selecting readable characters in defined touch zones.

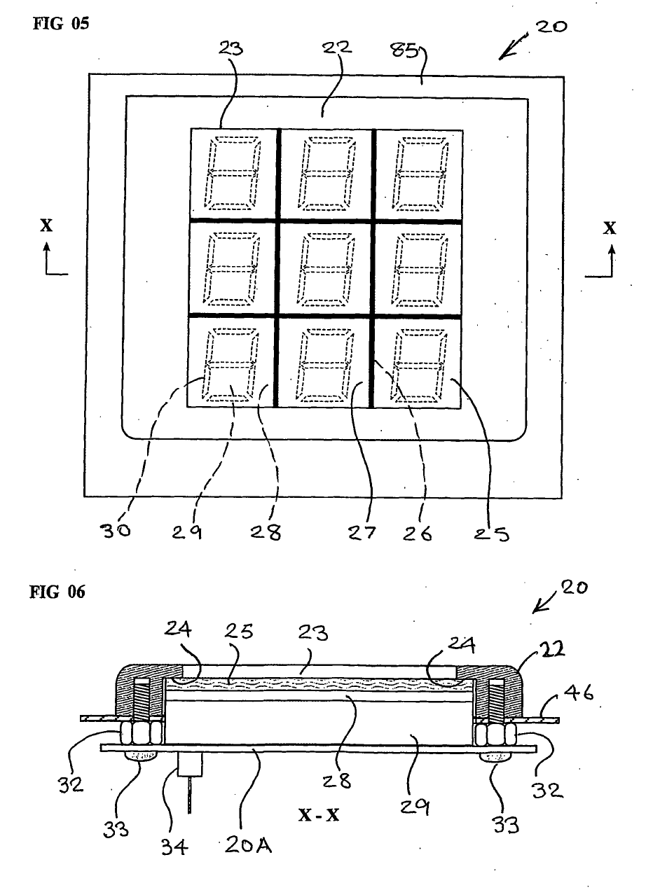

FIG. 06 shows a side elevation of view X-X in part cross section, of the sensor device in FIG. 05.

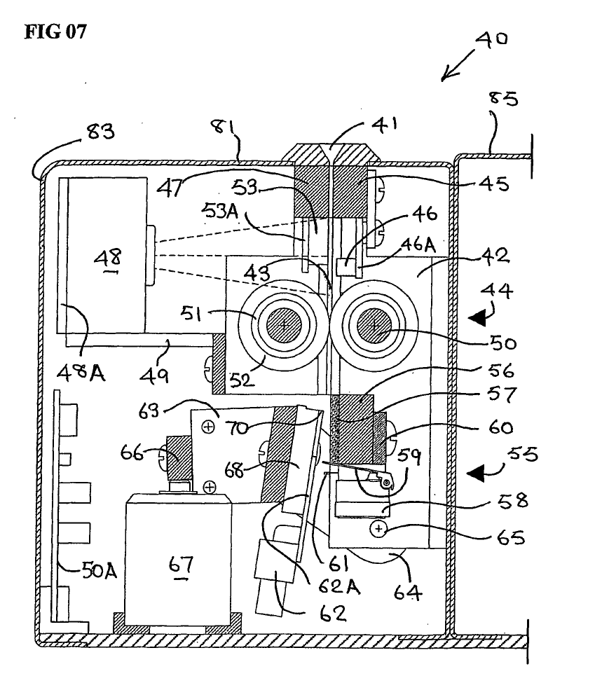

FIG. 07 shows a side view, in part cross section, of a guide device for use with a chip reader/writer and a scanner at a 1st-stop position and for use with a printer at a 2nd-stop position.

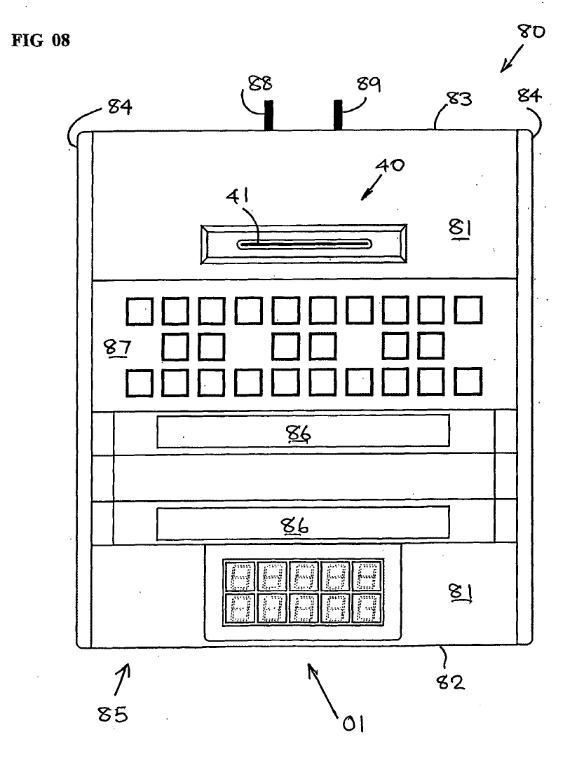

FIG. 08 shows the plan view of a computer terminal for originating a set of impersonal identifiers for anonymous registration, and for generating a set of impersonal identifiers for anonymous validation.

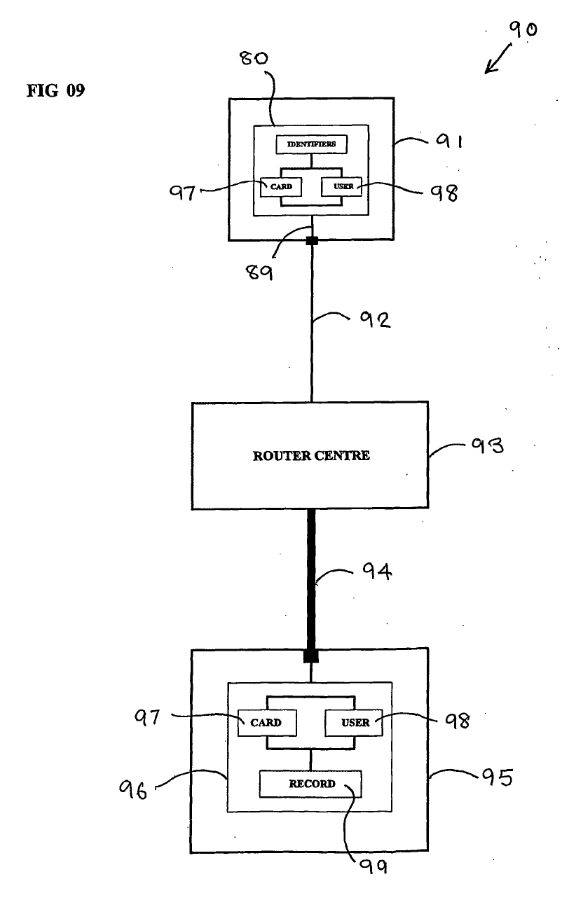

FIG. 09 shows a communication network for gateway routing impersonal identifiers and instruction identifiers between a computer terminal shown in FIG. 08 and a card-type server for anonymous registrations, and gateway routing impersonal identifiers and instruction identifiers between a computer terminal in FIG. 08 and a card-type server for anonymous validations.

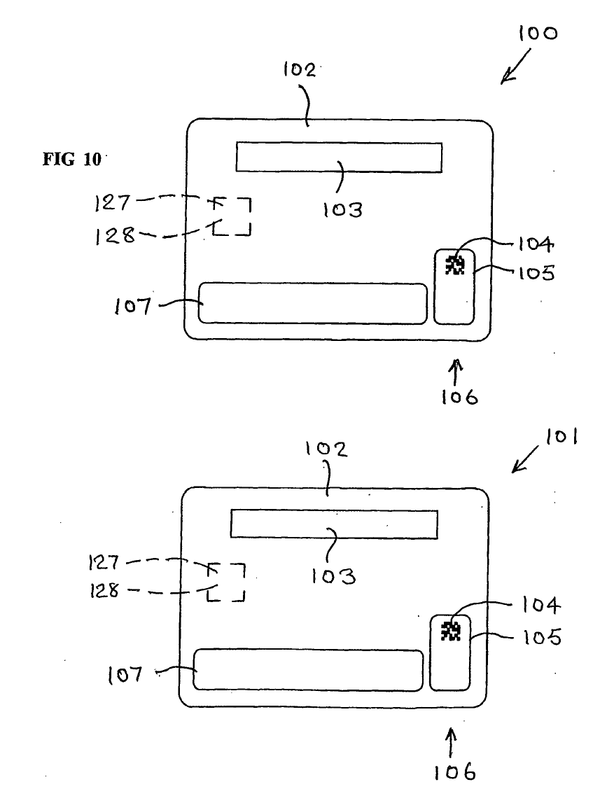

FIG. 10 shows an impersonal card and counterpart card in the unissued state for originating an impersonal card-identifier at a computer terminal and recording in a card-type server for an anonymous registration.

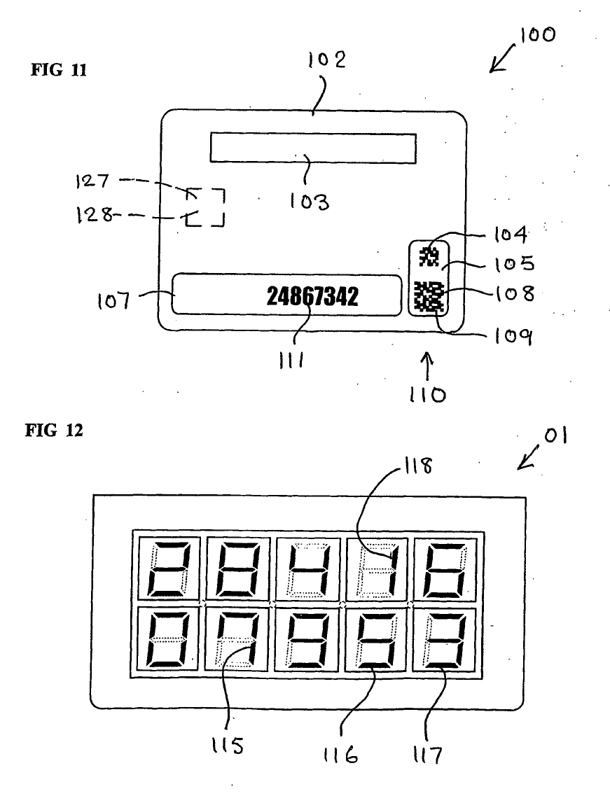

FIG. 11 shows the impersonal card of FIG. 10 with a concealed integrated circuit and with impersonal encoded data printed in the thermal coded area and impersonal ancillary data printed in the thermal panel area.

FIG. 12 shows the plan view of the sensor device with an illuminated numeral in each touch zone for originating an impersonal user-identifier at a computer terminal and recording in a card-type server for an anonymous registration.

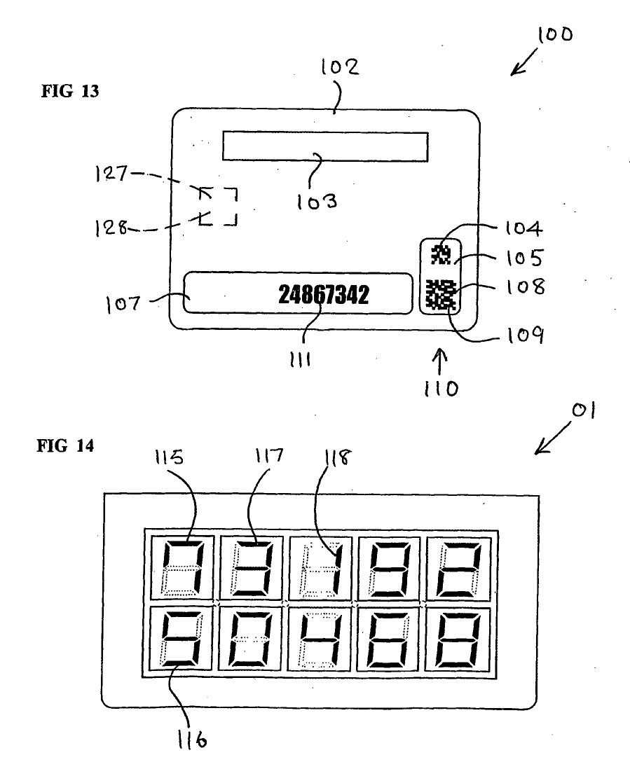

FIG. 13 shows an impersonal card in the issued state and valid state for generating an impersonal card-identifier at a computer terminal and matching in a card-type server for an anonymous validation.

FIG. 14 shows the plan view of the sensor device with an illuminated numeral in each touch zone for generating an impersonal user-identifier at a computer terminal and matching in a card-type server for an anonymous validation.

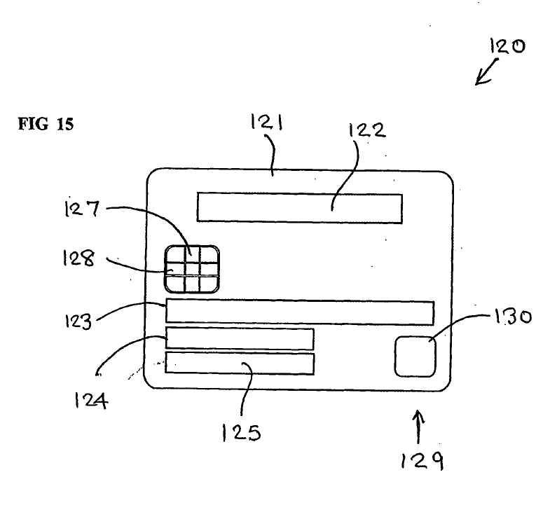

FIG. 15 shows a personal card in the unissued state for originating an impersonal card-identifier at a computer terminal and recording in a card-type server for anonymous registration.

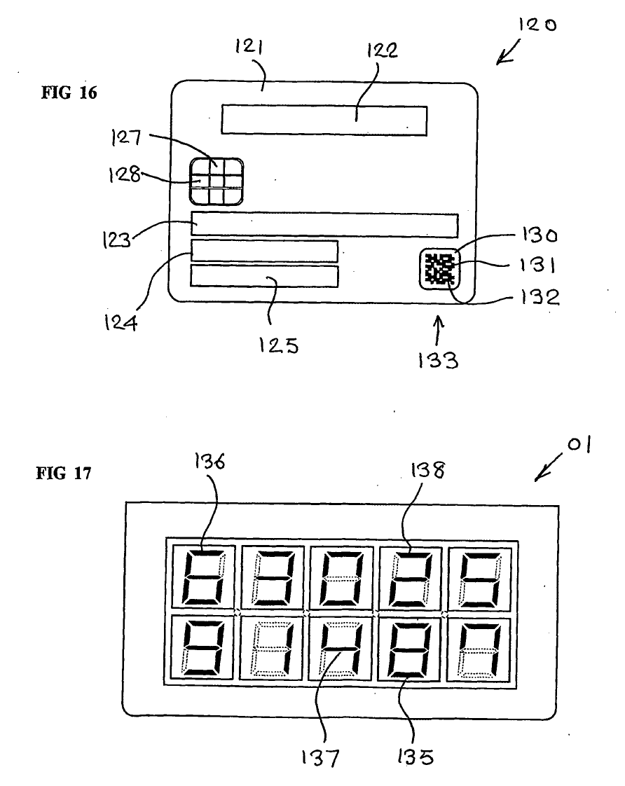

FIG. 16 shows the personal card of FIG. 15 with an exposed integrated circuit and with impersonal encoded data printed in the thermal coded area.

FIG. 17 shows the plan view of the sensor device with an illuminated numeral in each touch zone for originating an impersonal user-identifier at a computer terminal and recording in a card-type server for an anonymous registration.

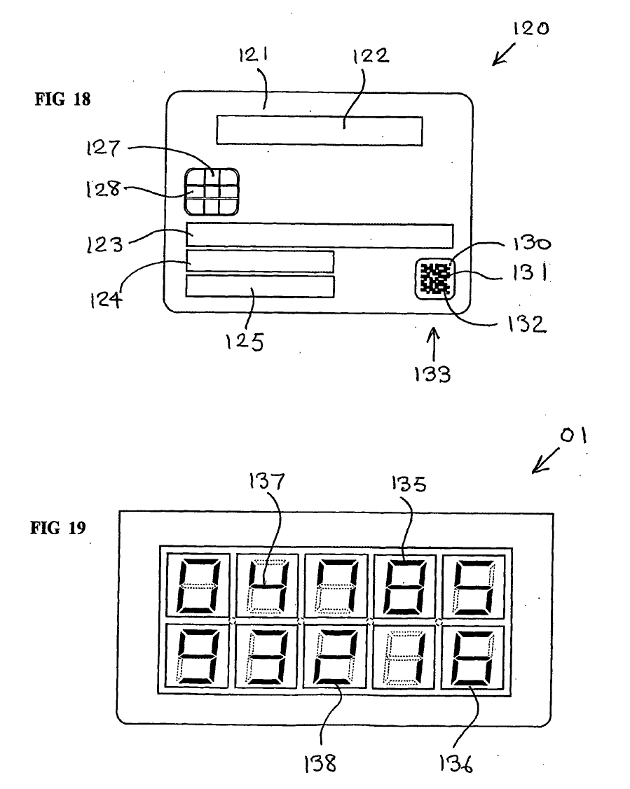

FIG. 18 shows a personal card in the issued state and valid state for generating an impersonal card-identifier at a computer terminal and matching in a card-type server for an anonymous validation.

FIG. 19 shows the plan view of the sensor device with an illuminated numeral in each touch zone for generating an impersonal user-identifier at a computer terminal and matching in a card-type server for an anonymous validation.

FIG. 20 shows the plan view of a computer terminal which communicates with a host computer for generating a set of impersonal identifiers for an anonymous validation.

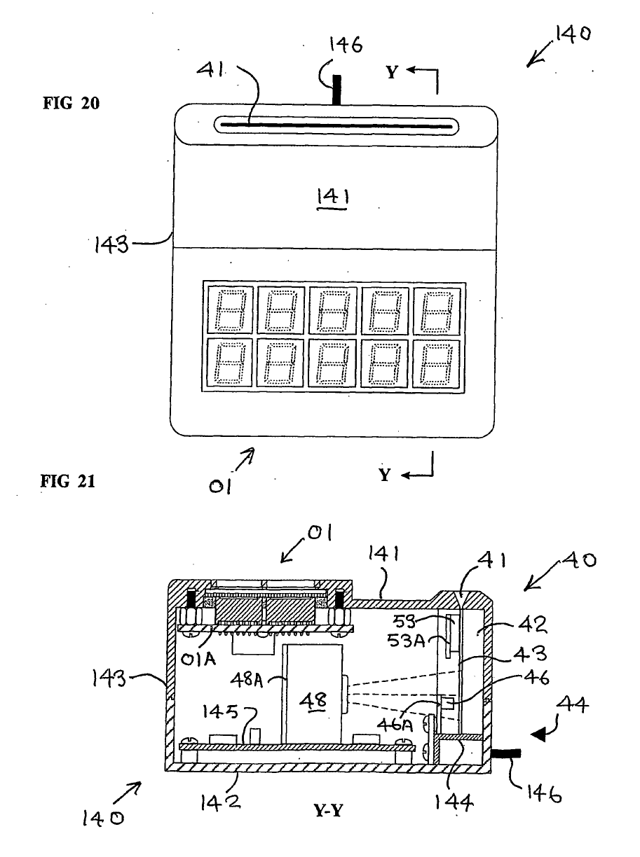

FIG. 21 shows a side elevation of view Y-Y in cross section, of a guide means for use with a chip reader/writer and a scanner at a 1st-stop position in the computer terminal shown in FIG. 20.

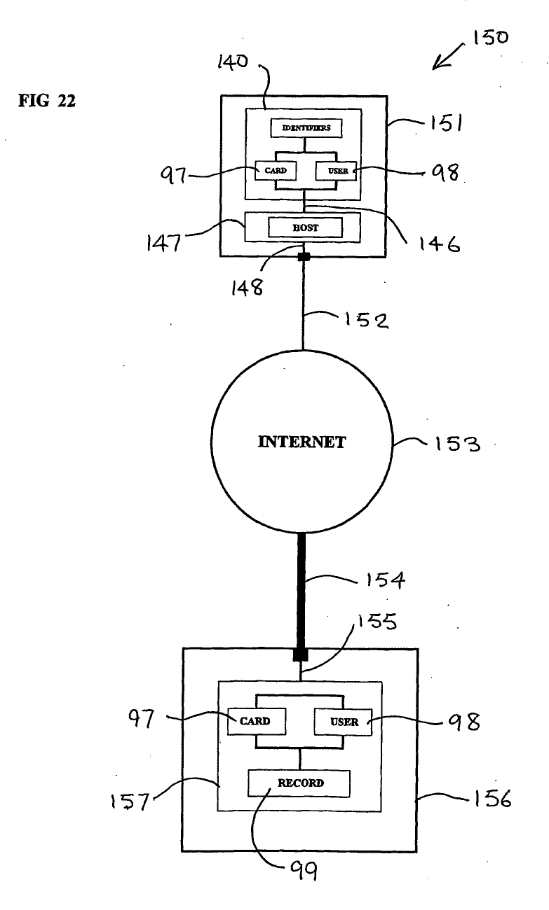

FIG. 22 shows a communication network for internet routing impersonal identifiers and instruction identifiers between a computer terminal shown in FIG. 20 connected to a host computer, and a card-type server for anonymous validations.

FIGS. 01 and 02 show a sensor device 01 mounted to a terminal casing 85. The sensor device 01 includes a moulded fascia 03 with a recessed surround 04 to support and locate a moulded grid 05 with discrete open areas to define ten touch zones 06 for selectively placing a finger or object in any touch zone 06 to make contact with a touch screen 07 underneath the moulded grid 05 to locate the position of the finger or object on the active area of the touch screen 07.

The touch screen 07 includes spaced apart passive areas indicated at reference 08 within the active area on the touch screen 07. The moulded grid 05 includes grid spacers 08 which rest on the said passive areas to prevent the moulded grid 06 resting on the active area of the touch screen 07. The touch screen 07 is a separate assembly for positioning on the underside of the recessed surround 04 which forms part of the moulded fascia 03 of sensor device 01.

Any known touch screen 07 with electrical sensing means may be used for detecting a finger or object in any touch zone 06 on the sensor device 01. The touch screen 07 incorporates a printed circuit (not shown) for connection to a socket 18 on a device board 01A for processing electrical signals received from the active area of the touch screen 07 every time a finger or object touches the surface within any touch zone 06 on the sensor device 01. Each touch zone 06 includes a vertical and horizontal co-ordinate to locate the position of each touch-zone 06 on the active area of the touch screen 07. Each touch zone 06 is therefore referenced on finger or object contact by a computer program.

The sensor device 01 also includes a filter element 09 and a spacer element 10 which are positioned underneath the touch screen 07 all of which are of similar surface area for locating in the moulded fascia 03 and held in place by the device board 01A which is rigidly fixed to the fascia 03 by screw means 16 and 17 as shown in FIG. 02.

The filter element 09 comprises a plurality of cavities in columnated formation and constructed of micro fine material, through which an illuminated character on each display element 13 is visible through the filter 09 and touch screen 07 when viewed directly in front of the sensor device 01, and is not visible when viewed from any side of the sensor device 01. The filter 09 therefore restricts the viewing angle on the sensor device 01 when used for selecting a concealed group of numerals in a public place such as an airport check-in and retail check-out or a cash-point for dispensing currency notes and coins.

The filter 09 may also be constructed in two parts to provide a sheet layer and cavity layer for positioning in the fascia 03 to restrict the viewing angle. The sheet layer may be coloured with optical clarity and the cavity layer may consist of any geometric formation in which the depth and width of each cavity may be adjusted to restrict the viewing angle to a greater or lesser degree for character recognition to select a concealed group of numerals on the sensor device 01. The filter element 09 may also be constructed of two sheet layers and each layer contains spaced apart vertical slats to form a filter element 09 with a restricted viewing angle from each side when the two layers are orientated at 90 degrees to each other. A coloured sheet layer may be placed above or below the two slatted sheet layers to provide a three layer filter element 09.

The spacer element 10 is fixed to the control board 12 using screws 11. Separate apertures are incorporated in the spacer 10 for each display element 13 to be inserted so that the top face of each display element 13 is level with the top face of the spacer 10 to form a level surface with a two row and five column configuration of display elements 13 which are spaced apart for positioning the centre of each display element 13 in the centre of each touch zone 06 as shown in FIGS. 1 and 2.

The device board 01A includes a printed circuit (not shown) for mounting thereon the discrete elements 13, each of which has contacts 14 for soldering to the printed circuit for independent electrical operation. Each display element 13 incorporates light emitting diodes for illuminating discrete segments 15 to display individual characters in each touch zone 06.

Each display element 13 may use any light source to illuminate discrete segment patterns or dot-matrix patterns in a variety of arrangements providing the arrangement of patterns can be replicated on each display element 13 in each touch zone 06 forming an interchangeable arrangement for character recognition to select a concealed group of numerals for an impersonal user-identifier on the sensor device 01. The arrangement of seven segments 15 shown in FIG. 01 is capable of illuminating ten different numerals on each display element 13 to display a variable numeral from zero to nine in each touch zone 06. This example is used hereinafter in the description for all figures.

The sensor device 01 includes control means to energise and de-energise the display elements 13 underneath the active area of each touch zone 06 every time a concealed group of numerals for an impersonal user-identifier are selected on the sensor device 01 by an individual user. Each touch zone 06 in the de-energised state is blank before and after the said group of numerals are selected, and each touch zone 06 in the energised state displays the ten concealed numerals in a random order to select the said group of numerals. The control means de-energises the display elements 13 each time the last numeral of the said group of numbers is selected by each and every individual user.

The sensor device 01 is intended for concealed use particularly in a public place and the position of each numeral on the sensor device 01 changes when the illuminated discrete segments 15 on each display element 13 are energised to illuminate a variable numeral in each touch zone 06 for selecting a concealed group of numerals within a restricted viewing angle by each individual user. Conventional key-pads use individual numbered key-switches which are arranged in a fixed numbered order on the key-pad for selecting a group of numbers in known positions. Each numbered key is visible for selecting a number in the known position on the key-pad for repeated use. By contrast in the present arrangement the position of each numeral on the sensor device 01 is unknown until the discrete segments 15 are energised to display an illuminated numeral in each of the touch zones 06 with an X and Y coordinate.

The device board 01A also includes a power and data socket 18 for the touch screen 07 to communicate with the device board 01A for processing the electrical signals received from the active area on the touch screen 07, and includes a power and data socket 19 for the device board 01A to communicate with a computer control board (not shown) for data transfer, and connecting a power supply to operate the display elements 13 and the touch screen 07. Associated electrical components (not shown) therefore form part of the printed circuit on the device board 01A and include integrated circuit components (not shown) for configuring and calibrating each touch zone 06 to operate the sensor device 01 controlled by computer programs for selecting a group of numerals to originate or generate impersonal user-identifiers for discrete card-types.

The sensor device 01 may also be constructed using display elements 13 made with liquid crystals and light emitting compounds for selecting a concealed group of characters in each touch zone 06 which may be stored in memory for generating array patterns with diverse arrangements in monochrome or colour.

In operation, the arrangement of illuminated discrete segments 15 shown in each display element 13 change order each time an individual card is inserted in a computer terminal for selecting a concealed group of numerals on the sensor device 01 to originate an impersonal user-identifier for recording in a card-type server. The same individual card is inserted again for selecting the same concealed group of numerals on the sensor device 01 to generate the same impersonal user-identifier for matching in the same card-type server.

The advantage of selecting a group of numerals located in different touch zones 06 with a restricted viewing angle, provides a concealed method for individual users to enter a group of numerals in selected order to originate or is generate impersonal user-identifiers in the terminal for discrete card-types on the sensor device 01 in a public place.

The sensor device 01 is intended for use with individual cards as described herein, whereby an impersonal site-identifier, impersonal card-identifier and impersonal user-identifier combine to form a set of impersonal identifiers for a card and user without reference to an individual person in a computer terminal. Alternatively, the sensor device 01 may be used for entering a concealed user-identifier, as an independent device for fitting to alternative types of computers and peripherals known per se. In this example, the sensor device 01 is used for selecting a concealed group of numerals to generate an impersonal user-identifier for matching in a terminal or a peripheral, which stores an original for comparison.

FIGS. 03 and 04 show different layouts for the touch zones 06 on the sensor 01, in which FIG. 03 shows nine touch zones 06 arranged in a three row and three column configuration and in which FIG. 04 shows twelve touch zones 06 arranged in a three row and four column configuration. Many configurations can be constructed as described for the sensor device 01 in FIGS. 01 and 02.

FIGS. 05 and 06 show a sensor device 20 of different construction which is mounted to a terminal casing 85. The sensor device 20 includes a moulded fascia 22 with an open area 23 and surrounding ledge 24 for locating a touch screen 25, a filter element 28 and a display panel 29 of similar surface area against the underside of the surrounding edge 24 which forms part of the moulded fascia 22 for sensor 20.

The touch screen 25 incorporates a register grid 26 to define nine touch zones 27 within the open area 23 for selectively placing a finger or object in any touch zone 27 to locate the position of the finger or object on the active area of the touch screen 25 of sensor device 20. The register grid 26 may therefore be printed on the underside of the touch screen 25 which is visible on the upper side of the touch screen 25. Alternatively, the register grid 26 may be incorporated in the filter element 28 to define the touch zones 27.

Any known touch screen 25 with electrical sensing means may be used for detecting a finger or object in any touch zone 27 on the sensor device 20. The touch screen 25 incorporates a printed circuit (not shown) for connection to a device board 20A for processing electrical signals received from the touch screen 25, every time a finger or object touches the surface within any touch zone 27 on the sensor device 20. Each touch zone 27 includes a vertical and horizontal co-ordinate to locate the position of each touch zone 27 on the active area of the touch screen 25. Each touch zone 27 is therefore referenced on finger or object contact by a computer program.

Any known display panel 29 capable of generating graphic images may be used, for example, passive or active matrix displays incorporating liquid crystals, vacuum fluorescent displays, pixel array displays or other visual display devices which are substantially constructed as a flat panel. The display panel 29 may also be incorporated within a larger screen such as the monitor screen in any automated teller machine (cash point) for displaying graphic images on a portion of the monitor screen which has touch screen functionality for selecting separate graphic images on the built-in sensor device 20 of the monitor screen. The display panel 29 and touch screen 25 are preferably constructed as an integral unit and may incorporate the filter element 28 to restrict the viewing angle on the sensor device 20 as previously described for the sensor device 01.

The display panel 29 in FIG. 05 consists of nine touch zones 27 in a typical three row and three column configuration, and shows the outline pattern of seven discrete segments 30 to indicate the position of a graphic image in each touch zone 27 for displaying a variable numeral from zero to nine in the centre of each touch zone 27 defined by the register grid 26. The discrete segments 30 are only visible to the individual user on activating the display panel 29 for character recognition through the filter element 28 and touch screen 25 using control means to energise and de-energise the liquid crystals which form the discrete segments 30 for selecting a concealed group of numerals on the sensor device 20 in each touch zone 27. The control means for the discrete segments 30 in FIG. 05 and the discrete segments 15 in FIG. 01 are similar in operation as previously described.

The graphic images displayed on the display panel 29 are not limited to an arrangement of segments or dot matrix patterns. Other arrangements may include bitmaps and vector images in the form of monochrome or colour pictures and symbols forming an interchangeable arrangement for image recognition to select a concealed group of graphic images on the sensor device 20. The graphic images are stored in memory for displaying in each touch zone 27 to form an arrangement for a specific card-type which may exceed the number of touch zones 27.

The device board 20A is a circuit connected to the display panel 29 and is shown fixed to the fascia 22 using four screws 32 and 33 to abut and fix the display panel 29, filter element 28 and touch screen 25 against the surrounding ledge 24 of the fascia 22. The device board 20A includes a printed circuit (not shown) and a power and data socket 34 for the device board 20A to communicate with a computer control board (not shown) for transferring processed data, and for connecting a power supply to operate the display panel 29 and the touch screen 25. Associated electrical components (not shown) therefore form part of the printed circuit on the device board 20A and include integrated circuit components (not shown) for configuring and calibrating each touch zone 27 to operate the sensor device 20 controlled by computer programs for selecting a concealed group of images for different card-types.

In operation, the arrangement of illuminated discrete segments 30 shown for selecting a numeral in each touch zone 27 on the sensor device 20, change each time an individual card is inserted in a computer terminal for selecting a concealed group of numerals on the sensor device 20 to originate an impersonal user-identifier for recording in a card-type server. The same individual card is inserted again for selecting the same concealed group of numerals on the sensor device 20 to generate the same impersonal user-identifier for matching in the same card-type server.

The advantage of selecting a group of numerals located in different touch zones 27 with a restricted viewing angle provides a concealed method for individual users to enter a group of numerals in selected order to originate or generate impersonal user-identifiers in the terminal for discrete card-types on the sensor device 20 in a public place.

The sensor device 20 is intended for use with individual cards as described herein, whereby an impersonal site-identifier, impersonal card-identifier and impersonal user-identifier combine to form a set of impersonal identifiers for a card and user without reference to an individual person in a computer terminal. Alternatively, the sensor device 20 may be used for entering a concealed user-identifier, as an independent device for fitting to alternative types of computers and peripherals known per se. In this example, the sensor device 20 is used for selecting a concealed group of numerals to generate an impersonal user-identifier for matching in a terminal or a peripheral, which stores an original for comparison.

FIG. 07 shows a guide device 40 mounted inside a terminal casing 85 with an external and detachable card-slot 41 to receive and identify cards 100, 120 in the unissued state and cards 100, 120 in the issued state for discrete card-types. The guide device 40 comprises two side supports 42 which are spaced apart to include guide grooves 43 in vertical alignment and engagement with each end of the transverse card-slot 41 to allow a card width to pass between the side supports 42 with each card edge retained in each guide groove 43 to a 1st-stop position 44 and to a 2nd-stop position 55. The side supports 42 are joined together by an upper transverse beam 45 and by a lower transverse beam 56 to provide a rigid structure for the guide device 40.

At the 1st-stop position 44, a switch 46 and device board 46A is shown and a light emitter (not shown) is offset mounted on the upper transverse beam 45 and transverse bar 47 to detect a card and illuminate a thermal coded area 105, 130 defined on the face of the card 100 or 120 and a scanner 48 and device board 48A is shown offset mounted on a transverse bracket 49 which is screwed to the side supports 42. A chip reader/writer 53 is shown mounted between the side supports 42 and is offset mounted on the transverse bar 47 in vertical alignment with the integrated circuit 127 concealed in the laminate material 102 for a card 100 or exposed on the laminate material 121 for a card 120, and is located in close proximity to the face of the card (without contact) at the 1st-stop position 44. The chip reader/writer 53 is a transceiver incorporating an antenna to emit a specific frequency radio signal with a defined acquisition range and includes the decoder device board 53A with power and data cables. These modules are of known type for writing or reading the discrete data 128 on an integrated circuit 127 to provide a read/write module 53 in the guide device 40 of the computer terminal 80 for a card 100 or a card 120. The discrete data 128 is a facial image.

The guide device 40 includes a drive means 50 controlled by a device board 50A comprising two transverse drive shafts 50 which are bearing mounted in the side supports 42 and driven by meshed gears and a stepper motor (not shown), all drive parts are mounted on the outside face of each side support 42. The drive shafts 50 support a pair of pinned nip-rollers 51 which are positioned in the centre of the guide 40 for either inward rotation to transport a card in the descent mode, or outward rotation to transport a card in the ascent mode. The nip-rollers 51 are shown rubber faced 52 for gripping each card face during the descent mode or ascent mode while the card is guided in each groove 43 to maintain vertical alignment.

At the 2nd-stop position 55, the lower transverse beam 56 is shown with a low friction layer 57 made of yielding material bonded thereon to provide a transverse support across the card width for pressure to be applied evenly on the card face and provide a transverse guide for the card to maintain vertical alignment in each groove 43. A switch 58 with lever 59 is shown mounted to a centre bracket 60 between two fixed stop plates 61 which are screwed to the lower transverse beam 56 to allow the lower card edge to depress the lever 59 to the level of the stop plates 61 and stop the nip-rollers 51 at the 2nd-stop position 56.

The guide device 40 includes a printer means 62 controlled by a device board 62A, comprising a transverse print-head 62 screwed on the front face of a transverse mounting 63 which includes lateral side plates 64 connected by pivot pins 65 to the outside face of each side support 42 for free pivotal movement. A transverse bar 66 is shown screwed to each end of the transverse mounting 63, and a solenoid 67 is shown positioned underneath the centre of the transverse bar 66 to apply a constant force and press the transverse print-head 62 at a predetermined pressure against the card face, supported by the low friction layer 57 during the ascent mode.

The transverse print-head 62 includes an integral heat-sink 68 and device board 62A with integrated circuits and cabling for power and data, and a row of micro-fine heating elements 70 as shown indicated, for dot-line printing in the coded area and in the panel area as defined on the front face of all individual cards for any discrete card-type. The guide 40 therefore includes registration datums for the chip reader/writer 53, the scanner 48 and printer 62 in specific positions determined by the integrated circuit 127 in the laminate material 102, 121 and the thermal coded area 105 and thermal panel area 107 on the card face.

The guide device 40 is intended for individual cards to be manually inserted to the 1st-stop position 44 and manually removed from the 1st-stop position 44 using one card-slot 41. The guide device 40 has two device operations A2 and B2 when individual cards for a discrete card-type are inserted in the card-slot 41 of a computer terminal 80. The two device operations are now described, by way of example, for a card 100 in the unissued state (A2) and a card 100 in the issued state (B2).

In the first operation, a card 100 in the unissued state is inserted in the card-slot 41 of the guide device 40 to the 1st-stop position 44. The switch 46 detects the guided card and activates the scanner 48 to capture a one-code image 106 in the thermal coded area 105 on the card face for a computer device to receive a bitmap of the one-code image 106 to verify the unissued state, and activates the chip reader/writer 53 to energise an integrated circuit 127 concealed in the laminate material of card 100 to receive a facial image from an external camera for writing discrete data 128 in the memory of the integrated circuit 127. The computer device in the terminal originates an impersonal card-identifier comprising of numeric data and encrypts the data into a registration code 108 and encodes into a symbology for printing encoded data 109 on the thermal coded area 105 of the card face. The computer device also originates ancillary data in the form of characters and symbols for dot-line printing on a thermal panel area 107 adjacent to the thermal coded area 105 on the card face.

The computer device writes the encoded data 109 and ancillary data 111 for the printer means 62 and instructs the drive means in the guide device 40 to activate the nip-rollers 51 for inward rotation to grip the guided card. At the start of the descent mode, the nip-rollers 51 transport the guided card to the 2nd-stop position 55 and stop inward rotation when the guided card depresses the lever 59 on switch 58 at the 2nd-stop position 55. The nip-rollers 51 stop momentarily to change to outward rotation for the ascent mode, to transport the guided card to the 1st-stop position 44.

At the start of the ascent mode, the solenoid 67 is energised to lift and press the print-head 62 against the front face of the guided card for dot-line printing the encoded data 109 in the thermal coded area 105 and for printing the ancillary data 111 in the thermal panel area as defined on the front face of the guided card. The solenoid 67 is de-energised for the print-head 62 to move away from the front face of the guided card caused by the weight of the transverse bar 66 to complete the print cycle during the ascent mode with the printed encoded data 109 displayed as a symbology in the thermal coded area 105 on the card face.

The nip-rollers 51 stop outward rotation when the guided card is at the 1st-stop position 44. The scanner 48 is activated to capture a two-coded image 110 in the thermal coded area 105 on the card face, for the computer device to receive a bitmap of the two-code image 110 and decode the symbology and decrypt the registration code 108, to verify that the printed registration code and the original card-identifier are exact copies for outbound transmission from terminal to server to create a card-type record for recording the original card-identifier to sanction an anonymous registration.

In the second operation, a card 100 in the issued state is inserted in the card-slot 41 of the guide device 40 to the 1st-stop position 44. The switch 46 detects the guided card and activates the scanner 48 to capture a two-code image 110 in the thermal coded area 105 on the card face for the computer device to receive a bitmap of the two-code image 110 to verify the issued state, and activates the chip reader/writer 53 to energise the integrated circuit 127 concealed in the laminate material of card 100 for reading discrete data 128 in the memory of the integrated circuit 127 to display the facial image on an external screen. The computer device decodes the symbology and decrypts the registration code 108 to generate a duplicate card-identifier for outbound transmission from terminal to server to locate the card-type record for matching the duplicate card-identifier to sanction an anonymous validation.

In operation, the guide device 40 provides means to receive and identify cards in the unissued state at the 1st-stop position 44 and printing on cards in the unissued state at the 2nd-stop position 55 for the device operation A2 and the guide device 40 provides means to receive and identify cards in the issued state at the 1st-stop position 44 for the device operation B2. Therefore, the guide device 40 may comprise of a one-stop cycle or a two-stop cycle for different types of computer terminal.

FIG. 08 shows the plan view of a computer terminal 80 for the device operations A1 to A6 and B1 to B6 as previously referenced for the primary function (A+B).

The computer terminal 80 is shown encased by a top face 81, front face 82, rear face 83, side panels 84 and base plate (not shown) to form a terminal casing 85 for supporting the external devices, which include the sensor 01 and device board 01A, dual display 86 and device boards 86A, keyboard 87 and device board 87A and position of the guide device 40 at card-slot 41, and further includes the power cable 88 and modem cable 89. The internal devices include the guide device 40 with switch 46 and device board 46A, scanner 48 and device board 48A, chip reader/writer 53 and device board 53A, emitter and device board, drive means 50 and device board 50A and printer means 62 with device board 62A, and the computer control board incorporating a modem device (not shown).

The computer control board includes printed circuits for mounting thereon, electrical components and integrated circuit components with circuit connection to the modem device and device boards 01A, 20A, 46A, 48A, 50A, 53A, 62A, 86A, 87A and emitter board (not shown), which collectively describes a computer device 80 to control the computer sequences (herein described) by computer programs for the device operations A1 to A6 and B1 to B6. The computer device 80 further includes associated connector points for internal power and data cables and connector points for the external modem cable 89 and power cable 88 which connects to an external power supply unit (PSU) for electrical mains supply.

The computer device 80 further includes computer programs for compiling numeric combinations to form sets of numeric data for individual site-identifiers, card-identifiers, user-identifiers and date-identifiers for discrete card-types, and includes programs for encrypting and decrypting data and encoding and decoding data referred to herein for card-type codes and registration codes on individual cards for each discrete card-type.

The computer terminal 80 further includes random access memory (RAM) for accessing encryption codes, communication identifiers and also accessing a terminal register for recording and identifying card-type codes to verify the card-issuer on every individual card for identification use or transaction use at the computer terminal 80.

The computer terminal 80 further includes storage for daily recording of point-of-sale transactions and the printing of daily records for cash or card payments including receipts using peripherals connected to the computer terminal 80.

The computer terminal 80 further includes modem means which is circuit connected to the computer means for the outbound transmission of numeric data from terminal to server and for the inbound transmission of numeric data from server to terminal to provide two-way communication for data processing impersonal identifiers and instruction identifiers for anonymous registrations and for anonymous validations.

FIG. 09 shows a diagrammatic layout of a communication network 90 for gateway routing impersonal identifiers and instruction identifiers for a discrete card-type between a terminal location 91 and a server location 95. The terminal location 91 is carrier-linked by a transmission line 92 to a router centre 93 and the server location 95 is carrier-linked by a transmission pipe 94 to the router centre 93 to form a basic infrastructure capable of expansion by replication.

The communication network 90 for a discrete card-type is expanded by increasing the number of terminal locations 91 at different site addresses for installing a computer terminal 80 at each terminal location 91, a typical network of 20,000 computer terminals 80 is envisaged at 20,000 terminal locations 91 and each terminal location 91 has a dedicated transmission line 92 carrier-linked to the router centre 93. The computer terminal 80 is connected by cable 89 to a junction box for the transmission line 92.

The communication network 90 for discrete card-types is expanded by increasing the number of server locations 95 at different site addresses for installing a card-type server 96 at each server location 95, a typical network of 200 card-type servers 96 is envisaged at 200 server locations 95 and each server location 95 has a dedicated transmission pipe 94 carrier-linked to the router centre 93. The card-type server 96 is connected by cable to a junction box for the transmission pipe 94.

The computer terminal 80 at the site address of each terminal location 91 is identified by a number and the card-type server 96 at the site address of each server location 95 is identified by a number, the two numbers are combined to form a 09-digit number and stored as a two-way communication identifier in each computer terminal 80 for routing a set of impersonal identifiers for a discrete card-type from the computer terminal 80 to the card-type server 96, and for routing a set of instruction identifiers for the discrete card-type from the card-type server 96 to the computer terminal 80. The communication identifier consists of a site-identifier for a server location 95 and a site-identifier for a terminal location 91.

Consequently, each computer terminal 80 can store 200 communication identifiers for 200 card-type servers 96 to form separate communication networks 90 comprising of 200 discrete card-type networks using the same computer terminal 80 at 20,000 terminal locations 91. A set of impersonal identifiers therefore includes at least, a site-identifier 95, a card-identifier 97 and a user-identifier 98 for outbound transmission, and a set of instruction identifiers includes at least, a site-identifier 91 and a file-identifier 99 for inbound transmission.

The router centre 93 provides the gateway for routing the volume of transmissions between the terminal locations 91 and the server locations 95, wherein the transmission line 92 for each terminal location 91 is identified by the terminal number, and the transmission pipe 94 for each server location 95 is identified by the server number for the gateway routing of transmissions.

Each transmission is a two-way communication. The outbound transmission from terminal 80 to server 96 comprises a set of numeric data in an arranged order to represent a set of impersonal identifiers which are transmitted to the server 96 for recording or matching at the server 96, and the inbound transmission from server 96 to terminal 80 comprises a set of numeric data in an arranged order to represent a set of instruction identifiers which are received at the terminal 80 and processed by the terminal computer to provide an indication as to whether the card and user are valid or invalid for accepting or rejecting at the computer terminal 80 to complete one transmission.

The set of numeric data for an outbound and inbound transmission may vary in file size, for example 200 bytes of data, and therefore each transmission has a short duration, for example 02-seconds. A communication network 90 comprising of 20,000 terminals 80 and one server 96 for a discrete card-type is carrying millions of transmissions per hour. By increasing the number of servers 96 for discrete card-types, the carrying capacity extends to an order of magnitude which may be replicated in every country for a global platform.

An embodiment of the present invention will now be described with reference to the arrangement of sequences listed below for each numbered group, in which a sequence group is selected to suit the card design for inserting in the guide device 40 to initiate the first sequence in any group. Consequently, the following description for each sequence group refers to receiving and identifying a card in the unissued state and writing discrete data and encoded data in or on the unissued card or receiving and identifying a card in the issued state and valid state and reading discrete data and encoded data carried on the issued card in the guide device 40.

Group 01

1-st guide sequence for A2

1-st computer sequence for A1

2-nd computer sequence for A1

3-rd computer sequence for A1

2-nd guide sequence for A2

3-rd guide sequence for A2

4-th computer sequence for A1+A3 and

1-st guide sequence for A2

1-st computer sequence for A1

2-nd computer sequence for A1

3-rd computer sequence for A1

2-nd guide sequence for A2

3-rd guide sequence for A2

5-th computer sequence for A1

1-st sensor sequence for A5

6-th computer sequence for A1

1-st modem sequence for A6

2-nd modem sequence for A6

7-th computer sequence for A1+A3

Group 02

1-st guide sequence for B2

1-st computer sequence for B1+B3

2-nd computer sequence for B1

1-st sensor sequence for B5

3-rd computer sequence for B1

1-st modem sequence for B6

2-nd modem sequence for B6

4-th computer sequence for B1+B3

Group 03

1-st guide sequence for B2

1-st computer sequence for B1+B3

2-nd computer sequence for B1

1-st keyboard sequence for B4

1-st sensor sequence for B5

3-rd computer sequence for B1

1-st modem sequence for B6

2-nd modem sequence for B6

4-th computer sequence for B1+B3

Group 04

1-st guide sequence for A2

1-st computer sequence for A1

2-nd computer sequence for A1

3-rd computer sequence for A1

2-nd guide sequence for A2

3-rd guide sequence for A2.

4-th computer sequence for A1

1-st sensor sequence for A5

5-th computer sequence for A1

1-st modem sequence for A6

2-nd modem sequence for A6

6-th computer sequence for A1+A3

Group 05

1-st guide sequence for B2

1-st computer sequence for B1+B3

2-nd computer sequence for B1

1-st sensor sequence for B5

3-rd computer sequence for B1

1-st modem sequence for B6

2-nd modem sequence for B6

4-th computer sequence for B1+B3

Group 06

1-st guide sequence for B2

1-st computer sequence for B1+B3

2-nd computer sequence for B1

1-st keyboard sequence for B4

1-st sensor sequence for B5

3-rd computer sequence for B1

1-st modem sequence for B6

2-nd modem sequence for B6

4-th computer sequence for B1+B3

Group 01 There will now be described with reference to FIGS. 10, 11 and 12, the device operations A1 to A6 to originate a set of impersonal identifiers for an anonymous registration to perform the primary function (A) using the computer terminal 80 in FIG. 08 and the communication network 90 in FIG. 09.

FIG. 10 shows an impersonal card 100 in the unissued state with a concealed integrated circuit 127 and a one-code image 106 which can be decoded and decrypted in the computer terminal 80 for printing a registration code 108 within the coded area 105 without reference to an individual person.

FIG. 11 shows the impersonal card 100 in the issued state with a concealed integrated circuit 127 and a two-code image 110 which can be decoded and decrypted in the computer terminal 80 for verifying the registration code 108 within the coded area 105 without reference to an individual person.

FIG. 12 shows the sensor device 01 with a group of numerals in the selected order 7531 for encrypting, to originate a user-identifier 98 in the computer terminal 80 without reference to an individual person.

In FIG. 10, each impersonal card 100 includes a counterpart card 101 and each part is inserted separately in the guide device 40 for writing the same discrete data 128 on each integrated circuit 127 and for terminal printing the same information on the impersonal card 100 and counterpart card 101 at the computer terminal 80. The counterpart card 101 is therefore a duplicate for handing to the card-issuer and the impersonal card 100 is an original for handing to a cardholder after anonymous registration in the database of a card-type server 96.

The impersonal card 100 and counterpart card 101 may be constructed of any sheet material 102 suitable for machine printing on both faces and may include a transparent film or coating on each face to provide a laminate material 102. The laminate material 102 further incorporates a middle layer which contains an integrated circuit 127 and an aerial embedded therein which communicates with an antenna on the chip reader/writer 53 to receive discrete data 128 for storing in the memory of the integrated circuit 127. An outer layer is laminated to each side of the middle layer to conceal the integrated circuit 127 within the laminate material 102. The middle layer may also store card-type codes 104 and encoded data 109 concealed in the laminate material 102 for the impersonal card 100 and the counterpart. The guide device 40 shows the chip reader/writer 53 positioned in close proximity to grooves 43 which guide the laminate material 102 at the 1st-stop position 44 for energising an integrated circuit 127 to write data thereto or read data therein at a specified radio frequency. The laminate material 102 may also include a material with inductance and or capacitance properties for storing an electric charge to power the integrated circuit 127 to receive and transmit the said data.

The impersonal card 100 and counterpart card 101 may also be constructed to include a thermal coating on each face of the impersonal card 100 and counterpart card 101 for terminal printing in a thermal coded area 105 and a thermal panel area 107. Alternatively, a layer of thermal material is affixed on the surface of the laminate material 102 as shown in FIG. 10, to raise and define the thermal coded area 105 and the thermal panel area 107 for terminal printing on the impersonal card 100 and the counterpart card 101 for a discrete card-type. The thermal coded area 105 and thermal panel area 107 are positioned in the same horizontal plane for terminal printing an encrypted registration code 108 in the form of encoded data 109 in the thermal coded area 105, and terminal printing ancillary data 111 in the thermal panel area 107, on the impersonal card 100 and counterpart card 101 for a double print cycle.

The impersonal card 100 and counterpart card 101 are machine printed with the name of the card-issuer in the referenced display area 103 to visually identify any card-type and are supplied by the card-issuer in the unissued state for inserting in the computer terminal 80 to originate a set of impersonal identifiers for an anonymous registration.

The impersonal card 100 and counterpart card 101 is pre-printed with a card-type code 104 in the coded area 105 for optical recognition in a guide device 40 to identify an individual card 100 for a discrete card-type. FIG. 10 shows the card-type code 104 in the form of a two dimensional symbology; any symbology or character set may be used for pre-printing an identity mark in the thermal coded area 105. The card-type code 104 is impersonal and the registration code 108 is impersonal and anonymous and is therefore unknown to a card-issuer and cardholder during the unissued state, the issued state, the issued and valid state.

The thermal material in the coded area 105 and in the panel area 107 is capable of changing state by thermo-chemical reaction or by thermo-chromic reaction to provide a permanent and irreversible two-code image 110 in the coded area 105 and provide permanent and irreversible ancillary data 111 in the panel area 107. Other security features can be incorporated in the thermal material such as holograms for visual inspection and passive circuits for radio frequency detection in the guide device 40, which are concealed for checking and rejecting counterfeit copies of the impersonal card 100 in the computer terminal 80.

The device operations A1 and A2 are performed by the computer device 80 and the guide device 40 according to the arranged order of sequences controlled by computer programs as set forth, by way of example.

The 1-st guide sequence for the device operation A2 comprises, manually inserting the counterpart card 101 in the card-slot 41, the card being guided by the grooves 43 to the 1st-stop position 44. The switch 46 detects the guided card 101 and activates the scanner 48 to capture a one-code image 106 on the unissued card 101 for data transfer to the computer device 80, and activates the chip reader/writer 53 to energise the concealed integrated circuit 127 for writing discrete data 128 in the memory of the integrated circuit 127. The discrete data 128 is a facial image captured on an external camera.

The computer device 80 receives a bitmap of the one-code image 106 to verify that the card-type code 104 is recorded in the terminal register of the computer terminal 80 to accept the counterpart card 101. The card-type code 104 consists of a 06-digit number which is decoded and decrypted for matching with a corresponding 06-digit number in the terminal register of the computer terminal 80. The terminal register stores unique 15-digit numeric combinations and each numeric combination is assigned to one card-issuer and is divided into two numeric groups, comprising a 06-digit number to identify the card-type for card-issuer matching in the terminal register and a 09-digit number to identify the two-way communication identifier for the card-type. Consequently, the 06-digit number is a numeric constant for precise matching in the terminal register and the 09-digit number forms the site-identifier for the server location 95 and the site-identifier for the terminal location 91.

The first computer sequence commences when two 06-digit numbers are matched to verify the card-type code 104 for identifying the card-issuer in the display area 103 on the counterpart card 101 in the said terminal register of the computer terminal 80.

The 1-st computer sequence for the device operation A1 comprises, compiling a 36-digit numeric combination, which is divided into the following numeric groups to form an original card-identifier 97 with point-of-origin indexing:

| Numeric | Indexer |
|---|---|
| 06 - digits | Card-type |
| 12 - digits | Data-entry |
| 08 - digits | Terminal |
| 10 - digits | Time and date |

The original card-identifier 97 therefore consists of impersonal data in the form of a constant 36-digit numeric combination and each numeric group identifies the card-type and the card-issuer, a data-entry for ancillary data, the number of the terminal location, and the time and date of origination, without reference to an individual person. The following example shows a collective series of constant numerals in each numeric group which forms an original card-identifier 97 in the computer terminal 80—132474 604282516937 29486058 1615220802.

The numeric combination and numeric groups may comprise of any quantity for recording and matching a set of impersonal identifiers, and each constant numeral may be concealed using a predetermined algorithm to alter the order and value for each constant numeral at a computer terminal 80 for reversion at a card-type server 96. The variations for recording and matching impersonal card-identifiers 97 are infinite.

The 2-nd computer sequence for the device operation A1 comprises, encrypting the 36-digit numeric combination into a registration code 108 to conceal the arranged order and combination of digits for printing the registration code 108 within the coded area 105 on the counterpart card 101 at the 2nd-stop position 55 in the guide device 40.

The 3-rd computer sequence for the device operation A1 comprises, encoding the registration code 108 and writing encoded data 109 together with ancillary data 111 to the printer means 62 in the guide device 40 for thermal printing the encoded data 109 within the coded area 105 on the counterpart card 101, and for thermal printing the ancillary data 111 within the panel area 107 on the counterpart card 101 at the 2nd-stop position 55 in the guide device 40.

The 2-nd guide sequence for the device operation A2 comprises, activating the drive means 50 to engage the counterpart card 101 at the 1st-stop position 44 and transport the counterpart card 101 in the descent mode to the 2nd-stop position 55 and transport the counterpart card 101 in the ascent mode to the 1st-stop position 44 (in sequential order) in the guide device 40. At the start of the ascent mode, the printer means 62 is pressed against the surface of the counterpart card 101 and the encoded data 109 is thermal printed in the coded area 105 and the ancillary data 111 is thermal printed in the panel area 107 during the ascent mode to complete a single print cycle in the guide device 40. A typical print cycle to form a thermal image 9 mm in height, comprises of 72 print pulses and each print pulse generates a row of dots referred to as a dot-line by energising the row of micro-fine heating elements 70 on the print-head 62 which are in contact with the surface of the counterpart card 101 during the single print cycle.

The 3-rd guide sequence for the device operation A2 comprises, activating the scanner 48 at the 1st-stop position 44 to capture a two-code image 110 in the coded area 105 for data transfer to the computer device 80.

The 4-th computer sequence for the device operation A1+A3 comprises, receiving a bitmap of the two-code image 110 for decoding and decrypting the registration code 108 to verify that the printed 36-digit registration code 108 matches the original 36-digit card-identifier 97 and to instruct the display device 86 to display a screen message to remove the counterpart card 101, followed by a screen message to insert the impersonal card 100. The said screen messages are operator instructions for the computer terminal 80.

The impersonal card 100 is now manually inserted in the card-slot 41 to the 1st-stop position 44 of the guide device 40. The following described sequences for the device operations A1 and A2 are repeated in the same sequential order for writing the same discrete data 128 to the integrated circuit 127, printing the same encoded data 109 in the coded area 104 and printing the same ancillary data 111 in the panel area 107 on the impersonal card 100:

the 1-st guide sequence for A2

the 1-st computer sequence for A1

the 2-nd computer sequence for A1

the 3-rd computer sequence for A1

the 2-nd guide sequence for A2

the 3-rd guide sequence for A2

The 5-th computer sequence for the device operation A1 comprises, verifying that the printed 36-digit registration code 108 matches the original 36-digit card-identifier 97 and confirming that the impersonal card 100 is in the issued state. The impersonal card 100 remains stationary in the computer terminal 80 at the 1st-stop position 44 in the guide device 40, to perform the device operation A5.

In FIG. 11, the impersonal card 100 is in the issued state and shows the coded area 105 with the machine printed card-type code 104 and the terminal printed registration code 108 in the form of encoded data 109, and shows the panel area 107 with a terminal printed card number described as ancillary data 111. The impersonal card 100 is not in the valid state for cardholder use at this stage.

The device operations A3 and A4 are performed by the display device 86 and the keyboard device 87 and are used during the computer sequences for A1, the guide sequences for A2, the sensor sequences for A5 and the modem sequences for A6. The display device 86 displays the operator instructions for each individual card for a discrete card-type and the keyboard device 87 is used according to the operator instructions for each individual card for a discrete card-type. A typical selection of operator instructions for the computer terminal 80 may comprise one or more of the following screen messages for any card in the unissued state or issued state: insert card-remove card-issue card-card accept-card reject-user accept-user reject-press reset-press print-enter value-enter number-press send-transaction accepted-transaction rejected.

The device operation A5 is performed by the sensor device 01 according to the description for FIGS. 01, 02 and 05, 06 for selecting a concealed group of numerals with the impersonal card 100 in the computer terminal 80 at the 1st-stop position 44 in the guide device 40.

In FIG. 12, the sensor device 01 shows an arrangement of illuminated discrete segments 15 in each touch zone 06 to display an individual numeral from zero to nine in each touch zone 06. The sensor device 01 is mounted on the computer terminal 80 shown in FIG. 08 for an individual user to select a concealed group of numerals. The referenced order 115, 116, 117 and 118 in FIG. 12 is used to input a 04-digit number in the selected order 7531 to describe the following sensor sequence and computer sequence.

The 1-st sensor sequence for the device operation A5 comprises, energising the display element 13 in each touch zone 06 and illuminating discrete segments 15, for displaying the ten different numerals in a random order in each touch zone 06, and detect the finger contact in any touch zone 06 to locate the position of each numeral in the selected order 7531 on the active area of the touch screen 07 for data transfer to the computer device 80. The display elements 13 are de-energised following the input of the 04-digit number to the computer device 80.

The 04-digit number is personal information known only to the user and is an incomplete part of a 36-digit numeric combination unknown to the user to form an original user-identifier 98 in the computer device 80 without reference to the individual person. A specific operator instruction is performed by the display device 86 and on the keyboard device 87 for the device operations A3 and A4 to input the gender of the user for an impersonal user-identifier. In operation, the display device 86 instructs the operator to press the send key for a male user or press the send key for a female user to transmit the set of numeric data with a gender identifier (1 or 0) for recording or matching in the database of a card-type server in accordance with any of the described sequence groups 01 to 06 for registration.

The 6-th computer sequence for the device operation A1 comprises, receiving the 04-digit number and encrypting it into a 36-digit numeric combination which is divided into the following numeric groups to form an original user-identifier 98 with point-of-origin constancy:

| Variant | Constant |
|---|---|
| 09-digits | 7 |
| 09-digits | 5 |
| 09-digits | 3 |
| 09-digits | 1 |

The original user-identifier 98 therefore consists of impersonal data in the form of a 36-digit numeric combination and each 09-digit numeric group consists of variant numerals with one constant numeral located therein, in the selected order according to its numerical value without reference to an individual person. The following example shows the underlined position of the constant numeral in each numeric group which forms part of the original user-identifier 98 in the computer terminal 80: 146289735 269158740 623817495 146725803

The numeric combination and numeric groups may comprise of any quantity for recording and matching a set of impersonal identifiers, and each constant numeral may be concealed using a pre-determined algorithm to alter the order and value for each constant numeral at a computer terminal 80 for reversion at a card-type server 96. The variations for recording and matching impersonal user-identifiers 98 are infinite.

The device operation A6 is performed by the modem device which forms part of the computer device 80 wherein, a site-identifier 95, a card-identifier 97, and a user-identifier 98 are combined in an arranged order to form a set of impersonal identifiers for outbound transmission from the terminal location 91 to the server location 95 to create a card-type record 99 for an anonymous registration at the card-type server 96, and wherein, a site-identifier 91 and a file-identifier 99 with recorded status or unrecorded status, are combined in an arranged order to form a set of instruction identifiers for inbound transmission from the server location 95 to the terminal location 91 to either accept the impersonal card 100 at the computer terminal 80 or reject the impersonal card 100 at the computer terminal 80.

The 1-st modem sequence for the device operation A6 comprises, transmitting a set of numeric data in an arranged order. The set of numeric data consists of an 81-digit numeric combination, divided into the following numeric groups for outbound transmission with point-of-origin identity:

| Numeric | Identifier |
|---|---|
| 09 - digits | site-identifiers |
| 36 - digits | card-identifier |
| 36 - digits | user-identifier |

The set of numeric data includes the impersonal site-identifier for server location 95 and terminal location 91 to form the two-way communication identifier for routing the set of numeric data to the database of the server 96 to create a card-type record 99 wherein, the 36-digit numeric group for the original card-identifier 97 is recorded in a 1-st datafile, and the 36-digit numeric group for the original user-identifier 98 is recorded in a 2-nd datafile, for recorded status to sanction an anonymous registration.

The 1-st datafile and 2-nd datafile of a card-type record 99 are used for recording and matching numeric groups with a constant order. Therefore, the constant numerals (36-digits) for an original and duplicate card-identifier 97 are matched in the database to complete a one-match sequence, and the constant numerals (04-digits) for an original and duplicate user-identifier 98 are matched in the database to complete a two-match sequence in a card-type server 96.

The 2-nd modem sequence for the device operation A6 comprises, receiving a set of numeric data from the card-type server 96 in an arranged order. The set of numeric data consists of a 18-digit numeric combination, divided into the following numeric groups for inbound transmission with point-of-origin identity:

| Numeric | Identifier |
|---|---|
| 09 - digits | site-identifiers |
| 09 - digits | file-identifiers |

The set of numeric data includes the impersonal site-identifier for server location 95 and terminal location 91 to form the two-way communication identifier for routing the set of numeric data to the computer terminal 80. The set of numeric data includes the file-identifier 99 to confirm that the original card-identifier 97 and original user-identifier 98 are recorded or unrecorded in the database of a card-type server 96. Consequently, the computer terminal 80 receives an inbound set of numeric data accepting a recorded file-identifier 99 or receives an inbound set of numeric data rejecting an unrecorded file-identifier 99.

The 7-th computer sequence for the device operation A1+A3 comprises, instructing the display device 86 to display a screen message to accept or reject the impersonal card 100, followed by a screen message to remove the impersonal card 100 from the computer terminal 80.

An impersonal card 100 with recorded status is a card accept and therefore is valid for cardholder use, and an impersonal card 100 with unrecorded status is a card reject and therefore invalid for cardholder use. The terminal operator hands over the valid impersonal card 100 to the impersonal user which entered the 04-digit number in the selected order 7531 at the computer terminal 80 to complete an anonymous registration.

The described device operations A1 to A6 are a preferred method to execute the primary function (A) using the computer terminal 80 in FIG. 08 and the communication network 90 in FIG. 09. The described modes of operation and sequences may be varied and are not precluded for executing the primary function (A) to originate a set of impersonal identifiers for an anonymous registration, according to the present invention.

Group 02 There will now be described with reference to FIGS. 13 and 14, the device operations B1 to B6 to duplicate a set of impersonal identifiers for an anonymous validation to perform the primary function (B) using the computer terminal 80 in FIG. 08 and the communication network 90 in FIG. 09.

FIG. 13 shows the impersonal card 100 in the issued state and valid state with a concealed integrated circuit 127 and a two-code image 110 for decoding and decrypting to generate a duplicate card-identifier 97 in the computer terminal 80 without reference to an individual person.

FIG. 14 shows the sensor device 01 with a group of numerals in the selected order 7531 for encrypting to generate a duplicate user-identifier 98 in the computer terminal 80 without reference to an individual person.

The device operations B1 and B2 are performed by the computer device 80 and the guide device 40 according to the arranged order of sequences controlled by computer programs as set forth, by way of example.

The 1-st guide sequence for the device operation B2 comprises, manually inserting the impersonal card 100 in the card-slot 41, the card being guided by the grooves 43 to the 1st-stop position 44. The switch 46 detects the guided card 100 and activates the scanner 48 to capture a two-code image 110 on the issued card 100 for data transfer to the computer device 80, and activates the chip reader/writer 53 to energise the concealed integrated circuit 127 for reading discrete data 128 in the memory of the integrated circuit 127. The discrete data 128 is a facial image displayed on an external screen.

The 1-st computer sequence for the device operation B1+B3 comprises, receiving a bitmap of the two-code image 110 for decoding and decrypting the card-type code 104 to verify that the 06-digit number is recorded in the terminal register of the computer terminal 80 to identify the card-type, and to instruct the display device 86 to display a screen message for card accept or card reject.

The 2-nd computer sequence for the device operation B1 comprises, accepting the card-type, reading the bitmap for decoding and decrypting the registration code 108 and compiling the 36-digit numeric combination into the numeric groups to form a duplicate card-identifier 97 with the same point-of-origin in the computer terminal 80: 132474 604282516937 29486058 1615220802.

In FIG. 13, the impersonal card 100 is shown in the issued state and in the valid state for cardholder use in the computer terminal 80. The same impersonal card 100 in FIG. 11 is shown in the issued state and is not in the valid state for cardholder use, to distinguish the difference between the card in FIG. 11 and the card in FIG. 13. The impersonal card 100 remains stationary in the computer terminal 80 at the 1st-stop position 44 in the guide device 40 to perform the device operation B5.

The device operations B3 and B4 are performed by the display device 86 and the keyboard device 87 and are used during the computer sequences for B1, the guide sequences for B2, the sensor sequences for B5 and the modem sequences for B6. The display device 86 displays the operator instructions for each individual card for a discrete card-type and the keyboard device 87 is used according to the operator instructions for each individual card for a discrete card-type. A typical selection of operator instructions for the computer terminal 80 may comprise one or more of the following screen messages for any card in the unissued state or issued state: insert card-remove card-issue card-card accept-card reject-user accept-user reject-press reset-press print-enter value-enter number-press send-transaction accepted-transaction rejected.

The device operation B5 is performed by the sensor device 01 according to the description for FIGS. 01, 02 and 05, 06 for selecting a concealed group of numerals with the impersonal card 100 in the computer terminal 80 at the 1st-stop position 44 in the guide device 40.

In FIG. 14, the sensor device 01 shows an arrangement of illuminated discrete segments 15 in each touch zone 06 to display an individual numeral from zero to nine in each touch zone 06. The sensor device 01 is mounted on the computer terminal 80 shown in FIG. 08 for an individual user to select a concealed group of numerals. The referenced order 115, 116, 117 and 118 is used in FIG. 14 to input a 04-digit number in the selected order 7531 to describe the following sensor sequence and computer sequence.

The 1-st sensor sequence for the device operation B5 comprises, energising the display element 13 in each touch zone 06, illuminating discrete segments 15 for displaying the ten different numerals in a random order in each touch zone 06, and detecting the finger contact in any touch zone 06 to locate the position of each numeral in the selected order 7531 on the active area of the touch screen 07 for data transfer to the computer device 80. The display elements 13 are de-energised following the input of the 04-digit number to the computer device 80.

The 04-digit number is personal information known only to the user and is an incomplete part of a 36-digit numeric combination unknown to the user to form an original user-identifier 98 in the computer device 80 without reference to the individual person. A specific operator instruction is performed by the display device 86 and on the keyboard device 87 for the device operations B3 and B4 to input the gender of the user for an impersonal user-identifier. In operation, the display device 86 instructs the operator to press the send key for a male user or press the send key for a female user to transmit the set of numeric data with a gender identifier (1 or 0) for recording or matching in the database of a card-type server in accordance with any of the described sequence groups 01 to 06 for registration.

The 3-rd computer sequence for the device operation B1 comprises, receiving the 04-digit number and encrypting it into a 36-digit numeric combination which is divided into the following numeric groups to form a duplicate user-identifier 98 with point-of-origin constancy:

| Variant | Constant |
|---|---|
| 09-digits | 7 |
| 09-digits | 5 |
| 09-digits | 3 |
| 09-digits | 1 |

The duplicate user-identifier 98 therefore consists of impersonal data in the form of a 36-digit numeric combination and each 09-digit numeric group consists of variant numerals with one constant numeral located therein, in the selected order according to its numerical value without reference to an individual person. The following example shows the underlined position of the constant numeral in each numeric group which forms part of the duplicate user-identifier 98 in the computer terminal 80: 721461756 348153245 143040692 130265402

The device operation B6 is performed by the modem device which forms part of the computer device 80 wherein, a site-identifier 95, a card-identifier 97, a user-identifier 98 and a date-identifier are combined in an arranged order to form a set of impersonal identifiers for outbound transmission from the terminal location 91 to the server location 95 to locate the card-type record 99 for matching at the card-type server 96, and wherein, a site-identifier 91 and a file-identifier 99 with matched status or unmatched status, are combined in an arranged order to form a set of instruction identifiers for inbound transmission from the server location 95 to the terminal location 91 accepting the card and user at the computer terminal 80 or rejecting the card and user at the computer terminal 80.

The 1-st modem sequence for the device operation B6 comprises, transmitting a set of numeric data in an arranged order. The set of numeric data consists of a 91-digit numeric combination, divided into the following numeric groups for outbound transmission with point-of-origin identity:

| Numeric | Identifier |
|---|---|
| 09 - digits | site-identifiers |
| 36 - digits | card-identifier |
| 36 - digits | user-identifier |
| 10 - digits | date-identifier |

The set of numeric data includes the impersonal site-identifier for server location 95 and terminal location 91 to form the two-way communication identifier for routing the set of numeric data to the database of the server 96 to locate a card-type record 99 wherein, the 36-digit numeric group for the duplicate card-identifier 97 is matched in the 1-st datafile, and the 36-digit numeric group for the duplicate user-identifier 98 is matched in the 2-nd datafile, for matched status to sanction an anonymous validation. The 10-digit numeric group for the date-identifier is recorded in a 3-rd datafile for matched status. The 10-digits consist of 04-digits for time and 06-digits for date.

The 1-st datafile and 2-nd datafile of a card-type record 99 are used for recording and matching numeric groups with a constant order. Therefore, the constant numerals (36-digits) for an original and duplicate card-identifier 97 are matched in the database to complete a one-match sequence, and the constant numerals (04-digits) for an original and duplicate user-identifier 98 are matched in the database to complete a two-match sequence in a card-type server 96.

The 2-nd modem sequence for the device operation B6 comprises, receiving a set of numeric data from the card-type server 96 in an arranged order. The set of numeric data consists of a 18-digit numeric combination, divided into the following numeric groups for inbound transmission with point-of-origin identity:

| Numeric | Identifier |
|---|---|
| 09 - digits | site-identifiers |
| 09 - digits | file-identifiers |

The set of numeric data includes the impersonal site-identifier for server location 95 and terminal location 91 to form the two-way communication identifier for routing the set of numeric data to the computer terminal 80. The set of numeric data includes the file-identifier 99 to confirm that the duplicate card-identifier 97 and duplicate user-identifier 98 are matched or unmatched in the database of a card-type server 96. Consequently, the computer terminal 80 receives an inbound set of numeric data accepting a matched file-identifier 99 or receives an inbound set of numeric data rejecting an unmatched file-identifier 99.

The 4-th computer sequence for the device operation B1+B3 comprises, instructing the display device 86 to display a screen message to accept or reject the impersonal card 100, followed by a screen message to remove the impersonal card 100 from the computer terminal 80.

An impersonal card 100 with matched status is a card accept and therefore valid for cardholder use, and an impersonal card 100 with unmatched status is a card reject and therefore invalid for cardholder use. The terminal operator hands over the valid impersonal card 100 to the impersonal user which entered the 04-digit number in the selected order 7531 at the computer terminal 80 to complete the anonymous validation.

The described device operations B1 to B6 are a preferred method to execute the primary function (B) using the computer terminal 80 in FIG. 08 and the communication network 90 in FIG. 09. The described modes of operation and sequences may be varied and are not precluded for executing the primary function (B) to generate a set of impersonal identifiers for an anonymous validation, according to the present invention.

Group 03 Is a preferred example for transaction use. The described 1-st modem sequence for the device operation B6 comprises transmitting the said set of numeric data in an arranged order with an additional 08-digit numeric group for a data-identifier which is recorded in the said card-type record 99. The data-identifier is a transaction value for authorised payment within a credit limit at the card-type record 99 and is recorded in a 4-th datafile during an anonymous validation. The 08-digit numeric group is originated by the 1-st keyboard sequence for the device operation B4 in advance of the 1-st sensor sequence for the device operation B5.

The 1-st keyboard sequence for the device operation B4 comprises, entering the transaction value for data transfer to the computer device 80 in response to a computer sequence for B1 to instruct the display device 86 to display a first screen message for the operator to enter the retail value on the keyboard 87 and instruct the display device 86 to display a second screen message for the cardholder to enter a 04-digit number in a selected order on the sensor 01. The impersonal card 100 remains inserted in the computer terminal 80 at the 1st-stop position 44 in the guide device 40 to perform the device operation B4 and subsequent device operations B5 and B6.

Group 04 There will now be described with reference to FIGS. 15, 16 and 17, the device operations A1 to A6 to originate a set of impersonal identifiers for an anonymous registration to perform the primary function (A) using the computer terminal 80 in FIG. 08 and the communication network 90 in FIG. 09.

FIG. 15 shows a personal card 120 in the unissued state with a card-type code 128 to decode and decrypt for printing a registration code 131 in the form of encoded data 132 in a thermal coded area 130 without reference to an individual person.

FIG. 16 shows the personal card 120 in the issued state with a one-code image 133 to decode and decrypt in the computer terminal 80 for verifying the registration code 131 in the thermal coded area 130 without reference to an individual person.

FIG. 17 shows the sensor device 01 with a group of numerals in the selected order 8642 for encrypting to originate a user-identifier 98 in the computer terminal 80 without reference to an individual person.

The personal card 120 may be constructed of any sheet material 121 suitable for machine printing on both faces and may include a transparent film or coating on each face to provide a laminate material 121. The laminate material 121 further incorporates a middle layer which contains an integrated circuit 127 and an aerial embedded therein which communicates with an antenna on the chip reader/writer 53 to receive discrete data 128 for storing in the memory of the integrated circuit 127. An outer layer is laminated to each side of the middle layer to conceal the integrated circuit 127 within the laminate material 121. The middle layer may also store card-type codes 128 and encoded data 132 concealed in the laminate material 121 for a personal card 120 and a counterpart. The guide device 40 shows the chip reader/writer 53 positioned in close proximity to grooves 43 which guide the laminate material 121 at the 1st-stop position 44 for energising an integrated circuit 127 to write data thereto or read data therein at a specified radio frequency. The laminate material 121 may also include a material with inductance and or capacitance properties for storing an electric charge to power the integrated circuit 127 to receive and transmit the said data.

The personal card 120 may also be constructed to include a thermal coating on each face of the personal card 120 for terminal printing in the thermal coded area 130. Alternatively, a layer of thermal material is affixed on the surface of the laminate material 121 as shown in FIG. 15, to raise and define the thermal coded area 130 for terminal printing on the personal card 120 for a discrete card-type. The thermal coded area 130 is positioned in the same vertical and horizontal plane for terminal printing encoded data 132 in the form of a two dimension symbology on the personal card 120 for a single print cycle.

FIGS. 15 and 16 show the personal card 120 constructed with an exposed integrated circuit 127 which contains a card-type code 128 to identify the card-type in the computer terminal 80. The personal card 120 is supplied by the card-issuer to the cardholder in the unissued state with pre-printed personal information, the account number 123, the expiry date 124 and the account name 125. The name of the issuer is printed in the display area 122. The personal information on any personal card 120 is superfluous according to the present invention, and is therefore disregarded for identification use or transaction use in any computer terminal 80. Consequently, a set of impersonal identifiers are not referenced to the personal information displayed or carried on the personal card 120.

The thermal material in the coded area 130 is capable of changing state by thermo-chemical reaction or by thermo-chromic reaction to provide a permanent and irreversible one-code image 133 printed thereon. Other security features are incorporated in the thermal material 121 comprising holograms for visual inspection and passive circuits for radio frequency detection in the guide device 40, which are concealed for checking and rejecting counterfeit copies of the personal card 120 in the computer terminal 80.

The device operations A1 and A2 are performed by the computer device 80 and the guide device 40 according to the arranged order of sequences controlled by computer programs as set forth, by way of example.

The 1-st guide sequence for the device operation A2 comprises, manually inserting the personal card 120 in the card-slot 41, the card being guided by the grooves 43 to the 1st-stop position 44. The switch 46 detects the guided card 120 and activates the scanner 48 to capture a blank image 129 on the unissued card 120 for data transfer to the computer device 80, and activates the chip reader/writer 53 to energise the concealed integrated circuit 127 for reading the card-type code 128 in the memory of the integrated circuit 127. The card-type code 128 is impersonal information recorded on a personal card 120 by the card-issuer.

The computer device 80 receives the card-type code 128 for decoding and decrypting to verify that the card-type code 128 is recorded in the terminal register of the computer terminal 80 to accept the personal card 120, and the computer device 80 receives a bitmap of the blank image 129 to verify that the personal card 120 is in the unissued state.

The card-type code 128 consists of a 06-digit number which is decoded and decrypted for matching with a corresponding 06-digit number in the terminal register of the computer terminal 80. The terminal register stores unique 15-digit numeric combinations and each numeric combination is assigned to one card-issuer and is divided into two numeric groups, comprising a 06-digit number to identify the card-type for card-issuer matching in the terminal register and a 09-digit number to identify the two-way communication identifier for the card-type. Consequently, the 06-digit number is a numeric constant for precise matching in the terminal register and the 09-digit number forms the site-identifier for the server location 95 and the site-identifier for the terminal location 91.

The first computer sequence commences when two 06-digit numbers are matched to verify the card-type code 128 for identifying the card-issuer in the display area 122 on the personal card 120 in the said terminal register of the computer terminal 80.

The 1-st computer sequence for the device operation A1 comprises, compiling a 36-digit numeric combination, which is divided into the following numeric groups to form an original card-identifier 97 with point-of-origin indexing:

| Numeric | Indexer |
|---|---|
| 06 - digits | Card-type |
| 12 - digits | Data-entry |
| 08 - digits | Terminal |
| 10 - digits | Time and date |

The original card-identifier 97 therefore consists of impersonal data in the form of a constant 36-digit numeric combination and each numeric group identifies the card-type and the card-issuer, a data-entry for ancillary data, the number of the terminal location, and the time and date of origination, without reference to an individual person. The following example shows a collective series of constant numerals in each numeric group which forms an original card-identifier 97 in the computer terminal 80: 548720 315874510368 59723054 0925130802.

The numeric combination and numeric groups may comprise of any quantity for recording and matching a set of impersonal identifiers, and each constant numeral may be concealed using a predetermined algorithm to alter the order and value for each constant numeral at a computer terminal 80 for reversion at a card-type server 96. The variations for recording and matching impersonal card-identifiers 97 are infinite.

The 2-nd computer sequence for the device operation A1 comprises, encrypting the 36-digit numeric combination into a registration code 131 to conceal the arranged order and combination of digits for thermal printing the registration code 131 in the coded area 130 on the personal card 120 at the 2nd-stop position 55 in the guide device 40.

The 3-rd computer sequence for the device operation A1 comprises, encoding the registration code 131 and writing encoded data 132 to the printer means 62 in the guide device 40 for thermal printing the encoded data 132 in the coded area 130 on the personal card 120 at the 2nd-stop position 55 in the guide device 40.

The 2-nd guide sequence for the device operation A2 comprises, activating the drive means 50 to engage the personal card 120 at the 1st-stop position 44 and transport the personal card 120 in the descent mode to the 2nd-stop position 55 and transport the personal card 120 in the ascent mode to the 1st-stop position 44 (in sequential order) in the guide device 40. At the start of the ascent mode, the printer means 62 is pressed against the surface of the personal card 120 and the encoded data 132 is thermal printed in the coded area 130 during the ascent mode to complete a single print cycle in the guide device 40. A typical print cycle to form a thermal image 9 mm in height, comprises of 72 print pulses and each print pulse generates a row of dots referred to as a dot-line by energising the row of micro-fine heating elements 70 on the print-head 62 which are in contact with the surface of the personal card 120 during the single print cycle.

The 3-rd guide sequence for the device operation A2 comprises, activating the scanner 48 at the 1st-stop position 44 to capture a one-code image 133 of the coded area 130 for data transfer to the computer device 80.

The 4-th computer sequence for the device operation A1 comprises, verifying that the printed 36-digit registration code 131 matches the original 36-digit card-identifier 97 and confirm that the personal card 120 is in the issued state. The personal card 120 remains stationary in the computer terminal 80 at the 1st-stop position 44 in the guide device 40, to perform the device operation A5.

In FIG. 16, the personal card 120 is in the issued state and shows the thermal coded area 130 with the terminal printed registration code 131 in the form of encoded data 132. The personal card 120 is not in the valid state for cardholder use at this stage.

The device operations A3 and A4 are performed by the display device 86 and the keyboard device 87, and are used during the computer sequences for A1, the guide sequences for A2, the sensor sequences for A5 and the modem sequences for A6. The display device 86 displays the operator instructions for each individual card for a discrete card-type and the keyboard device 87 is used according to the operator instructions for each individual card for a discrete card-type. A typical selection of operator instructions for the computer terminal 80 may comprise one or more of the following screen messages for any card in the unissued state or issued state: insert card-remove card-issue card-card accept-card reject-user accept-user reject-press reset-press print-enter value-enter number-press send-transaction accepted-transaction rejected.

The device operation A5 is performed by the sensor device 01 according to the description for FIGS. 01, 02 and 05, 06 for selecting a concealed group of numerals with the personal card 120 in the computer terminal 80 at the 1st-stop position 44 in the guide device 40.

In FIG. 17, the sensor device 01 shows an arrangement of illuminated discrete segments 15 in each touch zone 06 to display an individual numeral from zero to nine in each touch zone 06. The sensor device 01 is mounted on the computer terminal 80 shown in FIG. 08 for an individual user to select a concealed group of numerals. The referenced order 135, 136, 137 and 138 is used in FIG. 17 to input a 04-digit number in the selected order 8642 to describe the following sensor sequence and computer sequence.

The 1-st sensor sequence for the device operation A5 comprises, energising the display element 13 in each touch zone 06 and illuminating discrete segments 15, for displaying the ten different numerals in a random order in each touch zone 06, and detecting the finger contact in any touch zone 06 to locate the position of each numeral in the selected order 8642 on the active area of the touch screen 07 for data transfer to the computer device 80. The display elements 13 are de-energised following the input of the 04-digit number to the computer device 80.

The 04-digit number is personal information known only to the user and is an incomplete part of a 36-digit numeric combination unknown to the user to form a duplicate user-identifier 98 in the computer device 80 without reference to the individual person. A specific operator instruction is performed by the display device 86 and on the keyboard device 87 for the device operations A3 and A4 to input the gender of the user for an impersonal user-identifier. In operation, the display device 86 instructs the operator to press the send key for a male user or press the send key for a female user to transmit the set of numeric data with a gender identifier (1 or 0) for recording or matching in the database of a card-type server in accordance with any of the described sequence groups 01 to 06 for validation.

The 5-th computer sequence for the device operation A1 comprises, receiving the 04-digit number and encrypting it into a 36-digit numeric combination which is divided into the following numeric groups to form an original user-identifier 98 with point-of-origin constancy:

| Variant | Constant |
|---|---|
| 09-digits | 8 |
| 09-digits | 6 |
| 09-digits | 4 |
| 09-digits | 2 |

The original user-identifier 98 therefore consists of impersonal data in the form of a 36-digit numeric combination and each 09-digit numeric group consists of variant numerals with one constant numeral located therein, in the selected order according to its numerical value without reference to an individual person. The following example shows the underlined position of the constant numeral in each numeric group which forms part of the original user-identifier 98 in the computer terminal 80: 317416281 924806047 826405189 62315794

The numeric combination and numeric groups may comprise any quantity for recording and matching a set of impersonal identifiers, and each constant numeral may be concealed using a pre-determined algorithm to alter the order and value for each constant numeral at a computer terminal 80 for reversion at a card-type server 96. The variations for recording and matching impersonal user-identifiers 98 are infinite.

The device operation A6 is performed by the modem device which forms part of the computer device 80 wherein, a site-identifier 95, a card-identifier 97, and a user-identifier 98 are combined in an arranged order to form a set of impersonal identifiers for outbound transmission from the terminal location 91 to the server location 95 to create a card-type record 99 for an anonymous registration at the card-type server 96, and wherein, a site-identifier 91 and a file-identifier 99 with recorded status or unrecorded status, are combined in an arranged order to form a set of instruction identifiers for inbound transmission from the server location 95 to the terminal location 91 to either accept the personal card 120 at the computer terminal 80 or reject the personal card 120 at the computer terminal 80.

The 1-st modem sequence for the device operation A6 comprises, transmitting a set of numeric data in an arranged order. The set of data consists of an 81-digit numeric combination, divided into the following numeric groups for outbound transmission with point-of-origin identity:

| Numeric | Identifier |
|---|---|
| 09 - digits | site-identifiers |
| 36 - digits | card-identifier |
| 36 - digits | user-identifier |

The set of numeric data includes the impersonal site-identifier for server location 95 and terminal location 91 to form the two-way communication identifier for routing the set of numeric data to the database of the server 96 to create a card-type record 99 wherein, the 36-digit numeric group for the original card-identifier 97 is recorded in a 1-st datafile, and the 36-digit numeric group for the original user-identifier 98 is recorded in a 2-nd datafile, for recorded status to sanction an anonymous registration.

The 1-st datafile and 2-nd datafile of a card-type record 99 are used for recording and matching numeric groups with a constant order. Therefore, the constant numerals (36-digits) for an original and duplicate card-identifier 97 are matched in the database to complete a one-match sequence, and the constant numerals (04-digits) for an original and duplicate user-identifier 98 are matched in the database to complete a two-match sequence in a card-type server 96.

The 2-nd modem sequence for the device operation A6 comprises, receiving a set of numeric data from the card-type server 96 in an arranged order. The set of numeric data consists of a 18-digit numeric combination, divided into the following numeric groups for inbound transmission with point-of-origin identity:

| Numeric | Identifier |
|---|---|
| 09 - digits | site-identifiers |
| 09 - digits | file-identifiers |

The set of numeric data includes the impersonal site-identifier for server location 95 and terminal location 91 to form the two-way communication identifier for routing the set of numeric data to the computer terminal 80. The set of numeric data includes the file-identifier 99 to confirm that the original card-identifier 97 and original user-identifier 98 are recorded or unrecorded in the database of a card-type server 96. Consequently, the computer terminal 80 receives an inbound set of numeric data accepting a recorded file-identifier 99 or receives an inbound set of numeric data rejecting an unrecorded file-identifier 99.

The 6-th computer sequence for the device operation A1+A3 comprises, instructing the display device 86 to display a screen message to accept or reject the personal card 120, followed by a screen message to remove the personal card 120 from the computer terminal 80.

A personal card 120 with recorded status is a card accept and therefore valid for cardholder use, and a personal card 120 with unrecorded status is a card reject and, therefore invalid for cardholder use. The terminal operator hands over the valid personal card 120 to the impersonal user which entered the 04-digit number in the selected order 8642 at the computer terminal 80 to complete the anonymous registration.

The described device operations A1 to A6 are a preferred method to execute the primary function (A) using the computer terminal 80 in FIG. 08 and the communication network 90 in FIG. 09. The described modes of operation and sequences may be varied and are not precluded for executing the primary function (A) to originate a set of impersonal identifiers for an anonymous registration, according to the present invention.

Group 05 There will now be described with reference to the FIGS. 18 and 19, the device operations B1 to B6 to duplicate a set of impersonal identifiers for an anonymous validation to perform the primary function (B) using the computer terminal 80 in FIG. 08 and the communication network 90 in FIG. 09.

FIG. 18 shows the personal card 120 in the issued state and valid state with a one-code image 133 for decoding and decrypting to generate a duplicate card-identifier 97 in the computer terminal 80 without reference to an individual person.

FIG. 19 shows the sensor device 01 with a group of numerals in the selected order 8642 for encrypting to generate a duplicate user-identifier 98 in the computer terminal 80 without reference to an individual person.

The device operations B1 and B2 are performed by the computer device 80 and the guide device 40 according to the arranged order of sequences controlled by computer programs as set forth, by way of example.

The 1-st guide sequence for the device operation B2 comprises, manually inserting the personal card 120 in the card-slot 41 and is guided by the grooves 43 to the 1st-stop position 44. The switch 46 detects the guided card 120 and activates the scanner 48 to capture a one-code image 133 on the issued card 120 for data transfer to the computer device 80, and activates the chip reader/writer 53 to energise the concealed integrated circuit 127 for reading the card-type code 128 in the memory of the integrated circuit 127. The card-type code 128 is impersonal information recorded on a personal card 120 by the card-issuer.

The 1-st computer sequence for the device operation B1+B3 comprises, receiving the card-type code 128 for decoding and decrypting the card-type code 128 to verify that the 06-digit number is recorded in the terminal register of the computer terminal 80 to identify the card-type, and to instruct the display device 86 to display a screen message for card accept or card reject.

The 2-nd computer sequence for the device operation B1 comprises, accepting the card-type, reading the bitmap for decoding and decrypting the registration code 131 and compiling the 36-digit numeric combination into the numeric groups to form a duplicate card-identifier 97 with the same point-of-origin in the computer terminal 80: 548720 315874510368 59723054 0925130802.

In FIG. 18, the personal card 120 is shown in the issued state and in the valid state for cardholder use in the computer terminal 80. The same personal card 120 in FIG. 16 is shown in the issued state and is not in the valid state for cardholder use, to distinguish the difference between the card in FIG. 16 and the card in FIG. 18. The personal card 120 remains stationary in the computer terminal 80 at the 1st-stop position 44 in the guide device 40 to perform the device operation B5.

The device operations B3 and B4 are performed by the display device 86 and the keyboard device 87, and are used during the computer sequences for B1, the guide sequences for B2, the sensor sequences for B5 and the modem sequences for B6. The display device 86 displays the operator instructions for each individual card for a discrete card-type and the keyboard device 87 is used according to the operator instructions for each individual card for a discrete card-type. A typical selection of operator instructions for the computer terminal 86 may comprise one or more of the following screen messages for any card in the unissued state or issued state: insert card-remove card-issue card-card accept-card reject-user accept-user reject-press reset-press print-enter value-enter number-press send-transaction accepted-transaction rejected.

The device operation B5 is performed by the sensor device 01 according to the description for FIGS. 01, 02 and 05, 06 for selecting a concealed group of numerals with the personal card 120 in the computer terminal 80 at the 1st-stop position 44 in the guide device 40.

In FIG. 19, the sensor device 01 shows an arrangement of illuminated discrete segments 15 in each touch zone 06 to display an individual numeral from zero to nine in each touch zone 06. The sensor device 01 is mounted on the computer terminal 80 shown in FIG. 08 for an individual user to select a concealed group of numerals. The referenced order 135, 136, 137 and 138 is used in FIG. 19 to input a 04-digit number in the selected order 8642 to describe the following sensor sequence and computer sequence.

The 1-st sensor sequence for the device operation B5 comprises, energising the display element 13 in each touch zone 06 and illuminating discrete segments 15 for displaying the ten different numerals in a random order in each touch zone 06, and detecting the finger contact in any touch zone 06 to locate the position of each numeral in the selected order 8642 on the active area of the touch screen 07 for data transfer to the computer device 80. The display elements 13 are de-energised following the input of the 04-digit number to the computer device 80.

The 04-digit number is personal information known only to the user and is an incomplete part of a 36-digit numeric combination unknown to the user to form a duplicate user-identifier 98 in the computer device 80 without reference to the individual person. A specific operator instruction is performed by the display device 86 and on the keyboard device 87 for the device operations B3 and B4 to input the gender of the user for an impersonal user-identifier. In operation, the display device 86 instructs the operator to press the send key for a male user or press the send key for a female user to transmit the set of numeric data with a gender identifier (1 or 0) for recording or matching in the database of a card-type server in accordance with any of the described sequence groups 01 to 06 for validation.

The 3-rd computer sequence for the device operation B1 comprises, receiving the 04-digit number and encrypting it into a 36-digit numeric combination which is divided into the following numeric groups to form a duplicate user-identifier 98 with point-of-origin constancy:

| Variant | Constant |
|---|---|
| 09-digits | 8 |
| 09-digits | 6 |
| 09-digits | 4 |
| 09-digits | 2 |

The duplicate user-identifier 98 therefore consists of impersonal data in the form of a 36-digit numeric combination and each 09-digit numeric group consists of variant numerals with one constant numeral located therein, in the selected order according to its numerical value without reference to an individual person. The following example shows the underlined position of the constant numeral in each numeric group which forms part of the duplicate user-identifier 98 in the computer terminal 80: 912616487 720506879 313456487 825703504

The device operation B6 is performed by the modem device which forms part of the computer device 80 wherein, a site-identifier 96, a card-identifier 97, a user-identifier 98 and a date-identifier are combined in an arranged order to form a set of impersonal identifiers for outbound transmission from the terminal location 91 to the server location 95 to locate the card-type record 99 for matching at the card-type server 96, and wherein, a site-identifier 91 and a file-identifier 99 with matched status or unmatched status, are combined in an arranged order to form a set of instruction identifiers for inbound transmission from the server location 95 to the terminal location 91 accepting the card and user at the computer terminal 80 or rejecting the card and user at the computer terminal 80.

The 1-st modem sequence for the device operation B6 comprises, transmitting a set of numeric data in an arranged order. The set of numeric data consists of a 91-digit numeric combination, divided into the following numeric groups for outbound transmission with point-of-origin identity:

| Numeric | Identifier |
|---|---|
| 09 - digits | site-identifiers |
| 36 - digits | card-identifier |
| 36 - digits | user-identifier |
| 10 - digits | date-identifier |

The set of numeric data includes the impersonal site-identifier for server location 95 and terminal location 91 to form the two-way communication identifier for routing the set of data to the database of the server 96 to locate a card-type record 99 wherein, the 36-digit numeric group for the duplicate card-identifier 97 is matched in the 1-st datafile, and the 36-digit numeric group for the duplicate user-identifier 98 is matched in the 2-nd datafile, for matched status to sanction an anonymous validation. The 10-digit numeric group for the date-identifier is recorded in a 3-rd datafile for matched status. The 10-digits consist of 04-digits for the time and 06-digits for the date.

The 1-st datafile and 2-nd datafile of a card-type record 99 are used for recording and matching numeric groups with a constant order. Therefore, the constant numerals (36-digits) for an original and duplicate card-identifier 97 are matched in the database to complete a one-match sequence, and the constant numerals (04-digits) for an original and duplicate user-identifier 98 are matched in the database to complete a two-match sequence in a card-type server 96.

The 2-nd modem sequence for the device operation B6 comprises, receiving a set of numeric data from the card-type server 96 in an arranged order. The set of numeric data consists of a 18-digit numeric combination, divided into the following numeric groups for inbound transmission with point-of-origin identity:

| Numeric | Identifier |
|---|---|
| 09 - digits | site-identifiers |
| 09 - digits | file-identifiers |

The set of numeric data includes the impersonal site-identifier for server location 95 and terminal location 91 to form the two-way communication identifier for routing the set of numeric data to the computer terminal 80. The set of numeric data includes the file-identifier 99 to confirm that the duplicate card-identifier 97 and duplicate user-identifier 98 are matched or unmatched in the database of a card-type server 96. Consequently, the computer terminal 80 receives an inbound set of numeric data accepting a matched file-identifier 99 or receives an inbound set of numeric data rejecting an unmatched file-identifier 99.

The 4-th computer sequence for the device operation B1+B3 comprises, instructing the display device 86 to display a screen message to accept or reject the personal card 120, followed by a screen message to remove the personal card 120 from the computer terminal 80.

A personal card 120 with matched status is a card accept and therefore valid for cardholder use, and a personal card 120 with unmatched status is a card reject and therefore invalid for cardholder use. The terminal operator hands over the valid personal card 120 to the impersonal user which entered the 04-digit number in the selected order 8642 at the computer terminal 80 to complete the anonymous validation.

The described device operations B1 to B6 are a preferred method to execute the primary function (B) using the computer terminal 80 in FIG. 08 and the communication network 90 in FIG. 09. The described modes of operation and sequences may be varied and are not precluded for executing the primary function (B) to generate a set of impersonal identifiers for an anonymous validation, according to the present invention.

Group 06 Is a preferred example for transaction use. The described 1-st modem sequence for the device operation B6 comprises, transmitting the said set of numeric data in an arranged order with an additional 08-digit numeric group for a data-identifier which is recorded in the said card-type record 99. The data-identifier is a transaction value for authorised payment within a credit limit at the card-type record 99 and is recorded in a 4-th datafile during an anonymous validation. The 08-digit numeric group is originated by the 1-st keyboard sequence for the device operation B4 in advance of the 1-st sensor sequence for the device operation B5.

The 1-st keyboard sequence for the device operation B4 comprises, entering the transaction value for data transfer to the computer device 80 in response to a computer sequence for B1 to instruct the display device 86 to display a first screen message for the operator to enter the retail value on the keyboard 87 and instruct the display device 86 to display a second screen message for the cardholder to enter a 04-digit number in a selected order on the sensor device 01. The personal card 120 remains inserted in the computer terminal 80 at the 1st-stop position 44 in the guide device 40 to perform the device operation B4 and subsequent device operations B5 and B6.

FIGS. 20 and 21 show the external plan view and internal section detail of a computer terminal 140 for the device operations B1, B3 and B5 as previously referenced for the primary function (B).

In FIG. 20, the computer terminal 140 is shown encased by a moulded fascia 141, incorporating a sensor device 01 and card-slot 41 and a moulded base 142 incorporating a cable connection, for fitting an external power and data cable 146 between the computer terminal 140 and a host computer 147 shown illustrated in FIG. 22. The moulded fascia 141 and moulded base 142 include side walls for abutment and location to form a terminal casing 143 comprising of two moulded parts which are bolted together, a bolt hole is located at each corner of the moulded base 142 with threaded inserts in the moulded fascia 141

In FIG. 21, the terminal casing 143 includes internal moulded sections to form a guide device 40 with spaced apart guide grooves 43 in vertical alignment and engagement with each end of the transverse card-slot 41 to allow a card to be manually inserted in the computer terminal 140 with each card edge retained in each guide groove 43 to a 1st-stop position 44.

At the 1st-stop position 44 a transverse stop-plate 144 is positioned underneath the guide grooves 43 and rigidly fixed to the moulded base 143. A switch 46 and device board 46A is shown and a light emitter (not shown) is offset mounted on the transverse stop-plate 144 to detect a card and illuminate a thermal coded area defined on the face of the card 100 or 120 and a scanner 48 and device board 48A is shown offset mounted on a computer control board 145. A chip reader/writer 53 is shown mounted between the side supports 42 and is offset mounted in vertical alignment with the integrated circuit 127 concealed in the laminate material 102 for a card 100 or exposed on the laminate material 121 for a card 120, and is located in close proximity to the face of the card (without contact) at the 1st-stop position 44. The chip reader/writer 53 is a transceiver incorporating an antenna to emit a specific frequency radio signal with a defined acquisition range and includes the decoder device board 53A with power and data cables. These modules are of known type for writing or reading discrete data 128 or writing and reading-card-type codes 128 on an integrated circuit 127 to provide a read/write module 53 in the guide device 40 of the computer terminal 140 for a card 100 or a card 120. The discrete data 128 is a facial image and the card-type code 128 is an issuer number.

The computer control board 145 is shown mounted to the moulded base 142 which includes integrated circuit components and electrical components with circuit connection to the device boards 01A, 53A, 46A, 48A and emitter board (not shown), which collectively describes a computer device 140 to control the computer sequences (herein described) by computer programs for the device operations B1, B2 and B5. The computer device 140 includes associated connector points for internal power and data cables and a connector for the external power and data cable 146 to the host computer 147.

The computer device 140 includes programs for compiling numeric combinations to form sets of numeric data for individual site-identifiers, card-identifiers, user-identifiers, date-identifiers and data-identifiers for discrete card-types, and includes programs for decoding, decrypting and encrypting referred to herein for card-type codes and registration codes on individual cards for discrete card-types.

The computer terminal 140 further includes programs for writing and reading discrete data 128 and writing and reading card-type codes 128 on integrated circuits 127 and includes random access memory (RAM) for accessing encryption codes, communication identifiers and accessing a terminal register for recording and identifying card-type codes 104 and 128 to verify the card-issuer on every individual card for identification use or transaction use at the computer terminal 140.

The computer terminal 140 includes a separate power source with plug adapter or uses the power source direct from the host computer 147, which may be a personal computer or laptop computer with monitor, keyboard and modem, controlled by programs to transmit sets of numeric data and receive sets of numeric data for anonymous validations.

FIG. 22 shows a diagrammatic layout of a communication network 150 for internet routing impersonal identifiers and instruction identifiers for discrete card-type between a terminal location 151 and a server location 156. The terminal location 151 is carrier-linked by a transmission line 152 to the internet depicted by the reference 153, and the server location 156 is carrier-linked by a transmission pipe 154 to the internet 153 to form a basic infrastructure capable of expansion by replication.

The terminal location 151 includes at least one computer terminal 140 connected by a power and data cable 146 to a host computer 147 which is connected by modem cable 148 to the transmission line 152 for communication access to the internet 153 at the terminal location 151.

The server location 156 includes at least one card-type server 157 connected by an internal cable 155 to the transmission pipe 154 for communication access to the internet 153 at the server location 156. The server location 156 is capable of installing many card-type servers 157, each connected by an internal cable 155 to the transmission pipe 154.

The communication network 150 for discrete card-types is expanded by increasing the number of terminal locations 151 at different site addresses for installing a computer terminal 140 and host computer 147 at each terminal location 151, a typical network of 500,000 computer terminals 140 is envisaged at 500,000 terminal locations 151 and each terminal location 151 has a dedicated transmission line 152 carrier-linked to the internet 163.

The computer terminal 140 at the site address of each terminal location 151 is identified by a number and the card-type server 157 at the site address of the server location 156 is identified by a number, the two numbers are combined to form a 09-digit number and stored as a two-way communication identifier in each computer terminal 140 for routing a set of impersonal identifiers for a discrete card-type from the host computer 147 to the card-type server 157, and for routing a set of instruction identifiers for the discrete card-type from the card-type server 157 to the host computer 147. The communication identifier consists of a site-identifier for the server location 156 and a site-identifier for a terminal location 151.

Consequently, each computer terminal 140 can store 200 communication identifiers for 200 card-type servers 157 at the server location 156 using the computer terminal 140 at 500,000 terminal locations 151. A set of impersonal identifiers therefore includes at least, a site-identifier 156, a card-identifier 97 and a user-identifier 98 for outbound transmission, and a set of instruction identifiers includes at least, a site-identifier 151 and a file-identifier 99 for inbound transmission.

The internet 153 provides the infrastructure for routing the volume of transmissions between the terminal locations 151 and the server location 156 wherein the transmission line 152 for each terminal location 151 is identified by the terminal number, and the transmission pipe 154 for the server location 156 is identified by the server number for the internet routing of transmissions.

Each transmission is a two-way communication. The outbound transmission from a computer terminal 140 comprises of a set of numeric data in an arranged order to transmit a set of impersonal identifiers for recording or matching at a card-type server 157, and the inbound transmission from a card-type server 157 comprises of a set of numeric data in an arranged order to receive a set of instruction identifiers for accepting or rejecting at the computer terminal 140 to complete one transmission.

The set of numeric data for an outbound and inbound transmission may vary in file size, for example 200 bytes of data, and therefore each transmission has a short duration, for example 02-seconds. A communication network 150 comprising of 500,000 terminals 140 and one server 157 for a discrete card-type is carrying millions of transmissions per hour. By increasing the number of terminals 140 for discrete card-types, the carrying capacity extends to an order of magnitude which may be replicated in every country for a global platform.

An embodiment of the present invention will now be described with reference to the arrangement of sequences listed below for each numbered group, in which a sequence group is selected to suit the card design for inserting in the guide device 40 to initiate the first sequence in any group. Consequently, the following description for each sequence group refers to receiving and identifying a card in the issued state and valid state and reading discrete data and encoded data carried on the valid card in the guide device 40.

Group 07

1-st guide sequence for B2

1-st computer sequence for B1

2-nd computer sequence for B1

1-st sensor sequence for B5

3-rd computer sequence for B1

4-th computer sequence for B1

and

1-st display sequence for B3

1-st modem sequence for B6

2-nd modem sequence for B6

2-nd display sequence for B3

Group 08

1-st guide sequence for B2

1-st computer sequence for B1

2-nd computer sequence for B1

1-st sensor sequence for B5

3-rd computer sequence for B1

4-th computer sequence for B1 and

1-st display sequence for B3

2-nd display sequence for B3

1-st modem sequence for B6

2-nd modem sequence for B6

3-rd display sequence for B3

Group 09

1-st guide sequence for B2

1-st computer sequence for B1

2-nd computer sequence for B1

1-st sensor sequence for B5

3-rd computer sequence for B1

4-th computer sequence for B1 and

1-st display sequence for B3

1-st modem sequence for B6

2-nd modem sequence for B6

2-nd display sequence for B3

Group 10

1-st guide sequence for B2

1-st computer sequence for B1

2-nd computer sequence for B1

1-st sensor sequence for B5

3-rd computer sequence for B1

4-th computer sequence for B1 and

1-st display sequence for B3

2-nd display sequence for B3

1-st modem sequence for B6

2-nd modem sequence for B6

3-rd display sequence for B3

Group 07 There will now be described with reference to FIGS. 13 and 14, a cardholder using the computer terminal 140 in combination with the host computer 147 to perform the primary function (B) using the communication network 150 shown in FIG. 22.

FIG. 13 shows an impersonal card 100 in the issued state and valid state with a two-code image 110 for decoding and decrypting to generate a duplicate card-identifier 97 in the computer terminal 140 without reference to an individual person.

FIG. 14 shows the sensor device 01 with a group of numerals in the selected order 7531 for encrypting, to generate a duplicate user-identifier 98 in the computer terminal 140 without reference to an individual person.

The device operations B1, B2 and B5 for the computer 140, guide 40 and sensor 01, are performed by the computer terminal 140, according to an arranged order of sequences controlled by computer programs as set forth, by way of example.

The 1-st guide sequence for the device operation B2 comprises, manually inserting the card 100 in the card-slot 41, the card being guided by the grooves 43 to the 1st-stop position 44. The switch 46 detects the guided card 100 and activates the scanner 48 to capture a two-code image 110 on the issued card 100 for data transfer to the computer device 140, and activates the chip reader/writer 53 to energise the concealed integrated circuit 127 for reading discrete data 128 in the memory of the integrated circuit 127. The discrete data 128 is a facial image displayed on an external screen.

The 1-st computer sequence for the device operation B1 comprises, receiving a bitmap of the two-code image 110 for decoding and decrypting the card-type code 104 to verify that the 06-digit number is recorded in the terminal register of the computer device 140 to identify the card-type.

The 2-nd computer sequence for the device operation B1 comprises, accepting the card-type, reading the bitmap for decoding and decrypting the registration code 108 and compiling the 36-digit numeric combination into the numeric groups to form a duplicate card-identifier 97 with the same point-of-origin in the computer terminal 140: 132474 604282516937 29486058 1615220802.

A program initiates the computer sequence for the device operation B5 with the impersonal card 100 inserted in the computer terminal 140. The sensor device 01 is described in FIGS. 01 and 02 and an alternative sensor device 20 is described in FIGS. 05 and 06. The sensor device 01 is shown fitted to the computer terminal 140 in FIGS. 20 and 21 for the cardholder to enter a concealed group of numerals in a selected order.

In FIG. 14, the sensor device 01 shows an arrangement of illuminated discrete segments 15 in each touch zone 06 to display an individual numeral from zero to nine in each touch zone 06. The referenced order 115, 116, 117 and 118 is used in FIG. 14 to input a 04-digit number in the selected order 7531 to describe the following sensor sequence and computer sequence.

The 1-st sensor sequence for the device operation B5 comprises, energising the display element 13 in each touch zone 06 and illuminating discrete segments 15 for displaying the ten different numerals in a random order in each touch zone 06, and detecting the finger contact in any touch zone 06 to locate the position of each numeral in the selected order 7531 on the active area of the touch screen 07 for data transfer to the computer device 140. The display elements 13 are de-energised following the input of the 04-digit number to the computer device 140.

The 04-digit number is personal information known only to the user and is an incomplete part of a 36-digit numeric combination unknown to the user to form a duplicate user-identifier 98 in the computer device 80 without reference to the individual person. A specific operator instruction is performed by the display device 86 and on the keyboard device 87 for the device operations B3 and B4 to input the gender of the user for an impersonal user-identifier. In operation, the display device 86 instructs the operator to press the send key for a male user or press the send key for a female user to transmit the set of numeric data with a gender identifier (1 or 0) for recording or matching in the database of a card-type server in accordance with any of the described sequence groups 07 to 10 for validation.

The 3-rd computer sequence for the device operation B1 comprises, receiving the 04-digit number and encrypt into a 36-digit numeric combination which is divided into the following numeric groups to form a duplicate user-identifier 98 with point-of-origin constancy:

| Variant | Constant |
|---|---|
| 09 - digits | 7 |
| 09 - digits | 5 |
| 09 - digits | 3 |
| 09 - digits | 1 |

The duplicate user-identifier 98 therefore consists of impersonal data in the form of a 36-digit numeric combination and each 09-digit numeric group consists of variant numerals with one constant numeral located therein, in the selected order according to its numerical value without reference to an individual person. The following example shows the underlined position of the constant numeral in each numeric group which forms part of the duplicate user-identifier 98 in the computer terminal 140: 864870721 328451021 763020540 183248741

The 4-th computer sequence for the device operation B1 comprises, compiling four numeric groups in the arranged order: 09-digits, 36-digits, 36-digits, 10-digits, to form a set of impersonal identifiers into a 91-digit numeric combination for data transfer from the computer terminal 140 to the host computer 147.

The device operations B3, B4 and B6 for a display, keyboard and modem are performed by the host computer 147, according to an arranged order of sequences controlled by computer programs as set forth, by way of example.

A program initiates the computer sequences for the device operation B3. The program enables the cardholder to read display information from the host computer 147 and use a pointing device such as a mouse, for identification use or transaction use with the impersonal card 100 inserted in the computer terminal 140. A typical selection of display information may comprise one or more of the following screen messages for any card in the issued state and valid state: insert card-remove card-card accept-card reject-user accept-user reject-press reset-enter value-enter number-press send-transaction accepted-transaction rejected.

The 1-st display sequence for the device operation B3 comprises, displaying the screen messages, card accept-user accept, in response to the data-transfer of the 91-digit numeric combination from the computer terminal 140 to the host computer 147.

A program initiates the computer sequences for the device operation B4. The program enables the cardholder to enter keyboard information to the host computer 147 for identification use or transaction use with the impersonal card 100 inserted in the computer terminal 140. Keyboard sequences are used according to program instructions where appropriate.

A program initiates the computer sequences for the device operation B6 to transmit a set of numeric data and receive a set of numeric data for a discrete card-type using the modem in the host computer 147 wherein, a site-identifier 156, a card-identifier 97, a user-identifier 98 and a date-identifier are combined in an arranged order to form a set of impersonal identifiers for outbound transmission from the terminal location 151 to the server location 156 to locate a card-type record 99 for matching at the card-type server 157, and wherein, a site-identifier 151 and a file-identifier 99 with matched status or unmatched status, are combined in an arranged order to form a set of instruction identifiers for inbound transmission from the server location 156 to the terminal location 151 accepting the card and user at the host computer 147 or rejecting the card and user at the host computer 147.

The 1-st modem sequence for the device operation B6 comprises, transmitting a set of numeric data in an arranged order. The set of numeric data consists of the 91-digit numeric combination, divided into the following numeric groups for outbound transmission with point-of-origin identity:

| Numeric | Identifier |
|---|---|
| 09 - digits | site-identifiers |
| 36 - digits | card-identifier |
| 36 - digits | user-identifier |
| 10 - digits | date-identifier |

The set of numeric data includes the impersonal site-identifier for server location 166 and terminal location 151 to form the two-way communication identifier for internet routing the set of numeric data to the database of the server 157 to locate the card-type record 99 wherein, the 36-digit numeric group for the duplicate card-identifier 97 is matched in the 1-st datafile, and the 36-digit numeric group for the duplicate user-identifier 98 is matched in the 2-nd datafile, for matched status to sanction an anonymous validation. The 10-digit numeric group for the date-identifier is recorded in a 3-rd datafile for matched status. The 10-digits consist of 04-digits for time and 06-digits for date.

The 1-st datafile and 2-nd datafile of a card-type record 99 are used for recording and matching numeric groups with a constant order. Therefore, the constant numerals (36-digits) for an original and duplicate card-identifier 97 are matched in the database to complete a one-match sequence, and the constant numerals (04-digits) for an original and duplicate user-identifier 98 are matched in the database to complete a two-match sequence in a card-type server 157.

The 2-nd modem sequence for the device operation B6 comprises, receiving a set of numeric data from the card-type server 157 in an arranged order. The set of numeric data consists of a 18-digit numeric combination, divided into the following numeric groups for inbound transmission with point-of-origin identity:

| Numeric | Identifier |
|---|---|
| 09 - digits | site-identifiers |
| 09 - digits | file-identifiers |

The set of numeric data includes the impersonal site-identifier for server location 156 and terminal location 151 to form the two-way communication identifier for internet routing the set of numeric data to the host computer 147. The set of numeric data includes the file-identifier 99 to confirm that the duplicate card-identifier 97 and duplicate user-identifier 98 are matched or unmatched in the database of a card-type server 157. Consequently, the host computer 147 receives an inbound set of numeric data accepting a matched file-identifier 99 or receives an inbound set of numeric data rejecting an unmatched file-identifier 99.

The 2-nd display sequence for the device operation B3 comprises, displaying the screen messages—transaction accepted or transaction rejected, followed by the screen message to remove the impersonal card 100 from the computer terminal 140. An impersonal card 100 with matched status is a card accept and therefore valid for cardholder use, and an impersonal card 100 with unmatched status is a card reject and therefore invalid for cardholder use. The cardholder removes the impersonal card 100 from the computer terminal 140 to complete the primary function (B).

In combination, the device operations B1, B2 and B5 for the computer terminal 140 and device operations B3, B4 and B6 for the host computer 147 are a preferred method to execute the primary function (B) using the communication network 150 in FIG. 22. The described modes of operation and sequences may be varied and are not precluded for executing the primary function (B) to generate a set of impersonal identifiers for an anonymous validation, according to the present invention.

Group 08 Is a preferred example for transaction use. The described 1-st modem sequence for the device operation B6 comprises, transmitting the said set of numeric data in an arranged order with an additional 08-digit numeric group for a data-identifier which is recorded in the said card-type record 99. The data-identifier is a transaction value for authorised payment within a credit limit at the card-type record 99 and is recorded in a 4-th datafile during an anonymous validation. The 08-digit numeric group is originated at the host computer 147.

A 3-rd display sequence for the device operation B3 comprises, displaying the screen message—50.00 GBP, the cardholder uses the mouse to accept or reject the transaction value displayed on the screen. Alternatively, the cardholder uses a keyboard sequence to enter the transaction value.

Group 09 There will now be described with reference to FIGS. 18 and 19, a cardholder using the computer terminal 140 in combination with the host computer 147 to perform the primary function (B) using the communication network 150 shown in FIG. 22.

FIG. 18 shows a personal card 120 in the issued state and valid state with a one-code image 133 for decoding and decrypting to generate a duplicate card-identifier 97 in the computer terminal 140 without reference to an individual person.

FIG. 19 shows the sensor device 01 with a group of numerals in the selected order 8642 for encrypting, to generate a duplicate user-identifier 98 in the computer terminal 140 without reference to an individual person.

The device operations B1, B2 and B5 for the computer 140, guide 40 and sensor 01, are performed by the computer terminal 140, according to an arranged order of sequences controlled by computer programs as set forth, by way of example.

The 1-st guide sequence for the device operation B2 comprises, manually inserting the card 120 in the card-slot 41, the card being guided by the grooves 43 to the 1st-stop position 44. The switch 46 detects the guided card 120 and activates the scanner 48 to capture a one-code image 133 on the issued card 120 for data transfer to the computer device 140, and activates the chip reader/writer 53 to energise the concealed integrated circuit 127 for reading the card-type code 128 in the memory of the integrated circuit 127. The card-type code 128 is impersonal information recorded on a personal card 120 by the card-issuer.

The 1-st computer sequence for the device operation B1 comprises, receiving the stored data 128 for decoding and decrypting the card-type code 128 to verify that the 06-digit number is recorded in the terminal register of the computer device 140 to identify the card-type.

The 2-nd computer sequence for the device operation B1 comprises, accepting the card-type, reading the bitmap for decoding and decrypting the registration code 131 and compiling the 36-digit numeric combination into the numeric groups to form a duplicate card-identifier 97 with the same point-of-origin in the computer terminal 140: 548720 315874510368 59723054 0925130802.

A program initiates the computer sequence for the device operation B5 with the personal card 120 inserted in the computer terminal 140. The sensor device 01 is described in FIGS. 01 and 02 and an alternative sensor device 20 is described in FIGS. 05 and 06. The sensor device 01 is shown fitted to the computer terminal 140 in FIGS. 20 and 21 for the cardholder to enter a concealed group of numerals in a selected order.

In FIG. 19, the sensor device 01 shows an arrangement of illuminated discrete segments 15 in each touch zone 06 to display an individual numeral from zero to nine in each touch zone 06. The referenced order 135, 136, 137 and 138 is used in FIG. 19 to input a 04-digit number in the selected order 8642 to describe the following sensor sequence and computer sequence.

The 1-st sensor sequence for the device operation B5 comprises, energising the display element 13 in each touch zone 06, illuminating discrete segments 15 for displaying the ten different numerals in a random order in each touch zone 06, and detecting the finger contact in any touch zone 06 to locate the position of each numeral in the selected order 8642 on the active area of the touch screen 07 for data transfer to the computer device 140. The display elements 13 are de-energised following the input of the 04-digit number to the computer device 140.

The 04-digit number is personal information known only to the user and is an incomplete part of a 36-digit numeric combination unknown to the user to form a duplicate user-identifier 98 in the computer device 80 without reference to the individual person. A specific operator instruction is performed by the display device 86 and on the keyboard device 87 for the device operations B3 and B4 to input the gender of the user for an impersonal user-identifier. In operation, the display device 86 instructs the operator to press the send key for a male user or press the send key for a female user to transmit the set of numeric data with a gender identifier (1 or 0) for recording or matching in the database of a card-type server in accordance with any of the described sequence groups 07 to 10 for validation.

The 3-rd computer sequence for the device operation B1 comprises, receiving the 04-digit number and encrypting it into a 36-digit numeric combination which is divided into the following numeric groups to form a duplicate user-identifier 98 with point-of-origin constancy:

| Variant | Constant |
|---|---|
| 09 - digits | 8 |
| 09 - digits | 6 |
| 09 - digits | 4 |
| 09 - digits | 2 |

The duplicate user-identifier 98 therefore consists of impersonal data in the form of a 36-digit numeric combination and each 09-digit numeric group consists of variant numerals with one constant numeral located therein, in the selected order according to its numerical value without reference to an individual person. The following example shows the underlined position of the constant numeral in each numeric group which forms part of the duplicate user-identifier 98 in the computer terminal 140: 470361481 325496854 025420493 226742168

The 4-th computer sequence for the device operation B1 comprises, compiling four numeric groups in the arranged order: 09-digits, 36-digits, 36-digits, 10-digits, to form a set of impersonal identifiers into a 91-digit numeric combination for data transfer from the computer terminal 140 to the host computer 147.

The device operations B3, B4 and B6 for a display, keyboard and modem are performed by the host computer 147, according to an arranged order of sequences controlled by computer programs as set forth, by way of example.

A program initiates the computer sequences for the device operation B3. The program enables the cardholder to read display information from the host computer 147 and use a pointing device such as a mouse, for identification use or transaction use with the personal card 120 inserted in the computer terminal 140. A typical selection of display information may comprise one or more of the following screen messages for any card in the issued state and valid state: insert card-remove card-card accept-card reject-user accept-user reject-press reset-enter value-enter number-press send-transaction accepted-transaction rejected.

The 1-st display sequence for the device operation B3 comprises, displaying the screen messages, card accept-user accept, in response to the data transfer of the 91-digit numeric combination from the computer terminal 140 to the host computer 147.

A program initiates the computer sequences for the device operation B4. The program enables the cardholder to enter keyboard information to the host computer 147 for identification use or transaction use with the personal card 120 inserted in the computer terminal 140. Keyboard sequences are used according to program instructions where appropriate.

A program initiates the computer sequences for the device operation B6 to transmit a set of numeric data and receive a set of numeric data for a discrete card-type using the modem in the host computer 147 wherein, a site-identifier 156, a card-identifier 97, a user-identifier 98 and a date-identifier are combined in an arranged order to form a set of impersonal identifiers for outbound transmission from the terminal location 151 to the server location 156 to locate a card-type record 99 for matching at the card-type server 157, and wherein, a site-identifier 151 and a file-identifier 99 with matched status or unmatched status, are combined in an arranged order to form a set of instruction identifiers for inbound transmission from the server location 156 to the terminal location 151 accepting the card and user at the host computer 147 or rejecting the card and user at the host computer 147.

The 1-st modem sequence for the device operation B6 comprises, transmitting a set of numeric data in an arranged order. The set of numeric data consists of the 91-digit numeric combination, divided into the following numeric groups for outbound transmission with point-of-origin identity:

| Numeric | Identifier |
|---|---|
| 09 - digits | site-identifiers |
| 36 - digits | card-identifier |
| 36 - digits | user-identifier |
| 10 - digits | date-identifier |

The set of numeric data includes the impersonal site-identifier for server location 156 and terminal location 151 to form the two-way communication identifier for internet routing the set of numeric data to the database of the server 157 to locate the card-type record 99 wherein, the 36-digit numeric group for the duplicate card-identifier 97 is matched in the 1-st datafile, and the 36-digit numeric group for the duplicate user-identifier 98 is matched in the 2-nd datafile, for matched status to sanction an anonymous validation. The 10-digit numeric group for the date-identifier is recorded in a 3-rd datafile for matched status. The 10-digits consist of 04-digits for time and 06-digits for date.

The 1-st datafile and 2-nd datafile of a card-type record 99 are used for recording and matching numeric groups with a constant order. Therefore, the constant numerals (36-digits) for an original and duplicate card-identifier 97 are matched in the database to complete a one-match sequence, and the constant numerals (04-digits) for an original and duplicate user-identifier 98 are matched in the database to complete a two-match sequence in a card-type server 157.

The 2-nd modem sequence for the device operation B6 comprises, receiving a set of numeric data from the card-type server 157 in an arranged order. The set of numeric data consists of a 18-digit numeric combination, divided into the following numeric groups for inbound transmission with point-of-origin identity:

| Numeric | Identifier |
|---|---|
| 09 - digits | site-identifiers |
| 09 - digits | file-identifiers |

The set of numeric data includes the impersonal site-identifier for server location 156 and terminal location 151 to form the two-way communication identifier for internet routing the set of numeric data to the host computer 147. The set of numeric data includes the file-identifier 99 to confirm that the duplicate card-identifier 97 and duplicate user-identifier 98 are matched or unmatched in the database of a card-type server 157. Consequently, the host computer 147 receives an inbound set of numeric data accepting a matched file-identifier 99 or receives an inbound set of numeric data rejecting an unmatched file-identifier 99.

The 2-nd display sequence for the device operation B3 comprises, displaying the screen messages-transaction accepted or transaction rejected, followed by the screen message to remove the personal card 120 from the computer terminal 140. A personal card 120 with matched status is a card accept and therefore valid for cardholder use, and a personal card 120 with unmatched status is a card reject and therefore invalid for cardholder use. The cardholder removes the personal card 120 from the computer terminal 140 to complete the primary function (B).

In combination, the device operations B1, B2 and B5 for the computer terminal 140 and device operations B3, B4 and B6 for the host computer 147 are a preferred method to execute the primary function (B) using the communication network 150 in FIG. 22. The described modes of operation and sequences may be varied and are not precluded for executing the primary function (B) to generate a set of impersonal identifiers for an anonymous validation, according to the present invention.

Group 10 is a preferred example for transaction use. The described 1-st modem sequence for the device operation B6 comprises, transmitting the said set of numeric data in an arranged order with an additional 08-digit numeric group for a data-identifier which is recorded in the said card-type record 99. The data-identifier is a transaction value for authorised payment within a credit limit at the card-type record 99 and is recorded in a 4-th datafile during an anonymous validation. The 08-digit numeric group is originated at the host computer 147.

A 3-rd display sequence for the device operation B3 comprises, displaying the screen message—50.00 GBP. The cardholder uses the mouse to accept or reject the transaction value displayed on the screen. Alternatively, the cardholder uses a keyboard sequence to enter the transaction value.

The identification system in all its aspects can be modified in many ways for card design and terminal design. The card design for an impersonal card 100 can consist of a one-part card in the unissued state and include an integrated circuit 127 with a one-code image 133. The card design for a personal card 120 can display a two-code image 110 and conceal the integrated circuit 127, and comprise of a two-part card 120 including a counterpart card 101. Any card design can include fan-fold attachments for machine printing and terminal printing. The front face of the laminate material 102 and 121 for a counterpart card may consist of a form layout for writing information thereon in the unissued state or issued state. Alternatively, separate application forms may be used for writing information thereon.

The sequence groups 01 to 10 describe the preferred embodiments for registering and validating a set of impersonal identifiers for an impersonal card 100 or a personal card 120 to summarise the inventive concept. The transmission sequences performed by the guide device 40 for the internal data transfer of discrete data 128, card-type codes 128 and encoded data 109 and 132 as described herein can also be used for writing and reading concealed data in the laminate materials 102 or 121 at the 1st-stop position 44, instead of printing and scanning images 106 and 110 in the thermal coded area 105 on a card 100, and instead of printing and scanning images 129 and 133 in the thermal coded area 130 on a card 120.

Card designs may be adapted for printing ancillary data 111 in the panel area 107 in the form of characters and symbols for lottery and promotion cards, and in particular, adapted for issuing debit cards in post offices. The variety of card-types extend to identification uses and transaction uses in financial services for retail and social and including security applications.

The guide device 40 can be adapted to include alternative printer means 62 for use with ribbon cassettes and ink or toner cartridges. Alternative drive means 50 can be used for transporting fan-fold material 102 and 121 in the ascent mode only. A suitable container for storing said material is positioned below the drive means 50 with a card-slot 41 above the drive means 50.

The computer terminals 80 and 140 are intended for security applications and are therefore sealed and include security features to cause controlled shutdown through forced access and all programs and stored data for originating and generating card-identifiers, user-identifiers, site identifiers, date identifiers and data-identifiers and including the card-type codes in the terminal register are erased from memory rendering the terminals useless and worthless. The said terminals are intended for electronic registration and validation in post offices, retail outlets, offices, terminus, airports, service stations and the like, and therefore vary in type and size, with and without attendant operation.

The devices described herein can be rearranged in suitable casings to provide cabinets and consoles for identification card-types and transaction card-types for use in automated teller machines, airport check-in machines, transport dispensing machines, security systems and the like. Small casing designs incorporating a guide device 40 with a 1st-stop function as shown in the computer terminal 140 may include telephone handsets, display screens, keyboards, receivers and speakers for use as laptops, mobile phones and video phones. In this portable form, the computer terminal 140 incorporates electrical components and integrated circuits for independent operation and may include battery power as well as mains power.

The card-design may be in the form of bank drafts and giro forms, airline tickets and boarding cards, season tickets and permits, licences and passports, visas, identity cards and medical cards, electronic display cards for vehicle toll charging and vehicle ignition cards, all of which are intended for electronic registration at a computer terminal 80 on public counters and for electronic validation at a computer terminal 140 in private homes and offices including public buildings. The electronic registration of excise cards may be displayed on vehicles for monitoring and tracking on public highways.

1-49. (canceled)

50. A card-based system for originating impersonal identifiers for an unissued card in a terminal which can communicate with a database, said system comprising at least one terminal including means for receiving and identifying a card in its unissued state, computing means for originating an impersonal card-identifier and recording a registration code on the card, input means enabling a user to input to said computing means selected characters, said input means including a plurality of zones, which are operable by the user to cause input of the selected characters, said zones being arranged such that the character with which each zone is associated can change each time a card is received by the receiving and identifying means, said input characters being used for originating an impersonal user-identifier, and means for transmitting the impersonal identifiers to said database for recording an original set of identifiers for a card and user without reference to an individual person.

51. A card-based system according to claim 50, wherein the terminal includes means to encrypt the original card-identifier into a registration code for recording on or in the card.

52. A card-based system according to claim 50, wherein the said terminal includes means for printing the registration code on the card and means for scanning the registration code on the card.

53. A card-based system according to claim 52, wherein the registration code is an encoded image produced by thermal printing.

54. A card-based system according to claim 50, wherein the said terminal includes means for writing the registration code to the card and means for reading the registration code in the card.

55. A card-based system according to claim 54, wherein the registration code is stored in the memory of an integrated circuit enveloped by material layers.

56. A card-based system for generating impersonal identifiers for an issued card in a terminal which can communicate with a database, said system comprising at least one terminal including means for receiving and identifying a card in its issued state, computing means for decrypting the registration code recorded on the card to generate an impersonal card-identifier, input means enabling a user to input to said computing means selected characters, said input means including a plurality of zones, which are operable by the user to cause input of the selected characters, and said zones being arranged such that the character with which each zone is associate can change each time a card is received by the receiving and identifying means, said input characters being used for originating an impersonal user-identifier, and means for transmitting the impersonal identifiers to said database for matching a duplicate set of identifiers for a card and user without reference to an individual person.

57. A card-based system according to claim 50, wherein the database is at a server located remotely from the or each terminal.

58. A card-based system according to claim 56, wherein the database is at a server located remotely from the or each terminal.

59. A card-based system according to claim 50, wherein the receiving and identifying means comprises a guide for guiding the card to selected positions for printing and scanning and to selected positions for writing and reading.

60. A card-based system according to claim 56, wherein the receiving and identifying means comprises a guide for guiding the card to selected positions for printing and scanning and to selected positions for writing and reading.

61. A card-based system according to claim 50, wherein each card has recorded thereon data indicative of the card-type and the terminal includes means for identifying said data to enable the computing means to verify the card-type.

62. A card-based system according to claim 56, wherein each card has recorded thereon data indicative of the card-type and the terminal includes means for identifying said data to enable the computing means to verify the card-type.

63. A card-based system according to claim 50, wherein each card includes an integrated circuit for storing in memory discrete data, and said terminal includes means for writing and reading the discrete data to the integrated circuit.

64. A card-based system according to claim 56, wherein each card includes an integrated circuit for storing in memory discrete data, and said terminal includes means for writing and reading the discrete data to the integrated circuit.

65. A card-based system according to claim 63, wherein the integrated circuit is concealed in the card.

66. A card-based system according to claim 65, wherein the integrated circuit is concealed in the card.

67. A card-based system according to claim 63, wherein the discrete data is a representation of a concealed facial image.

68. A card-based system according to claim 50, where each zone is arranged to display said characters.

69. A card-based system according to claim 56, where each zone is arranged to display said characters.

70. A card-based system according to claim 68, wherein the character displayed by each zone is visible only within a restricted viewing angle.

71. A card-based system according to claim 68, wherein each zone is touch sensitive and is operable by a user placing a finger or object thereon.

72. A card-based system according to claim 50, wherein the zones are arranged in rows and columns.

73. A card-based system according to claim 56, wherein the zones are arranged in rows and columns.

74. A card-based system according to claim 68, wherein each zone is arranged to display a numeral.

75. A card-based system according to claim 63, wherein each zone includes a filter.

76. A card-based system according to claim 50, wherein the or each terminal includes or has associated therewith display means for displaying messages and instructions and keyboard means for inputting data.

77. A card-based system according to claim 56, wherein the or each terminal includes or has associated therewith display means for displaying messages and instructions and keyboard means for inputting data.

78. A card-based system for transmitting numeric data from any terminal location to any server location wherein, the terminal includes means to compile and transmit a constant set of numeric data for recording a set of impersonal identifiers in a database, and compile and transmit a constant set of numeric data for matching a set of impersonal identifiers in a database.

79. A card-based system according to claim 78, wherein the numeric data for a card-identifier has a constant order for recording or matching in a database at a server location.

80. A card-based system according to claim 78, wherein the numeric data for a user-identifier has a constant order for recording or matching in a database at a server location.

81. A card-based system according to claim 78, wherein the numeric data include a numeral to record the gender of the user-identifier in a database at a server location.

82. A card-based system according to claim 78, wherein the numeric data includes a site-identifier for a terminal location and a server location, for two-way communication.

83. A card-based system according to claim 78, wherein the numeric data includes a date-identifier to record the day and time at a server or terminal location.

84. A card-based system according to claim 78, wherein the numeric data includes a data-identifier to record a transaction value at the server location.

85. A card-based system according to claim 78, wherein the numeric data includes a file-identifier to record an accept or reject condition at the server or terminal location.

86. A card-based system according to claim 78, wherein the numeric data is enciphered and deciphered by changing and reverting the order and value of a numeric combination at a terminal location and a server location.

87. A card-based system according to claim 56, wherein each terminal has associated therewith a host computer to which the terminal can transfer numeric data for transmission to the server database.

88. A card-based system according to claim 50, including a plurality of terminals which can undergo two-way communication with a plurality of servers.

89. A card-based system according to claim 56, including a plurality of terminals which can undergo two-way communication with a plurality of servers.

90. A card-based system according to claim 78, including a plurality of terminals which can undergo two-way communication with a plurality of servers.

91. A card-based system which can generate a set of impersonal identifiers for an issued card in a computer terminal having an associated host computer for matching at a card-type server, wherein the system comprises
a) a terminal which incorporates means for receiving and identifying an impersonal card in an issued state, means for capturing a first image on the card for input to computing means which can decode and decrypt the image to generate an impersonal card-identifier in the terminal,
b) the terminal including sensor means with touch zones for illuminating an arrangement of segments in each touch zone to display within a restricted viewing angle, a random order of characters for a user to enter a concealed group of characters in a selected order for input to the computer to enable said computer to generate an impersonal user-identifier in the terminal,
c) the terminal being arranged to transfer the impersonal card-identifier and impersonal user-identifier to a host computer and
d) the host computer incorporates a modem to transmit a set of impersonal identifiers to locate a card-type record in the database of the card-type server for comparing the set of impersonal identifiers with data in the database, said modem being arranged to receive in response a set of instruction identifiers from the host computer indicative of the validity of the card and user.

92. A card-based system as claimed in claim 91, wherein all the data transmitted between the host computer and the server is in numeric form.

93. A card-based system comprising a network of computer terminals and a network of card-type servers which form separate communication networks for discrete card-types, and each network including integral means for originating impersonal identifiers at any computer terminal and for recording impersonal identifiers at the card-type server, said integral means for originating and recording the set of impersonal identifiers for an unissued card-type comprising:
a) means to receive and identify a card-type in the unissued state in a terminal,
b) means in the terminal to write discrete data to an integrated circuit incorporated in the card,
c) means in the terminal to originate an impersonal card-identifier for the card,
d) means in the terminal to originate an encrypted registration code for encoding and recording on the card,
e) means in the terminal to input a group of numerals and originate an impersonal user-identifier for the card,
f) means to transmit a set of impersonal identifiers for the card-type to a card-type server,
g) means to create a card-type record in the database of a card-type server for recording the set of impersonal identifiers, and
h) means to transmit a set of instruction identifiers to the terminal to indicate the validity of the card and the user.

94. A card-based system comprising a network of computer terminals and a network of card-type servers which form separate communication networks for discrete card-types, and each network including integral means for generating impersonal card-identifiers at any computer terminal and matching impersonal identifiers at the card-type server, the integral means for generating and matching a set of impersonal identifiers for an issued card-type comprising:
a) means to receive and identify a card-type in the issued state in a terminal,
b) means in the terminal to read discrete data on an integrated circuit incorporated in the card,
c) means in the terminal to decode and decrypt a registration code on the card to generate an impersonal card-identifier,
d) means in the terminal to input a group of numerals and generate an impersonal user-identifier for the card,
e) means to transmit a set of impersonal identifiers for the card-type to a card-type server,
f) means to locate a card-type record in the database of the card-type server for matching the set of impersonal identifiers, and
g) means to transmit a set of instruction identifiers to the terminal to indicate the validity of the card and the user.

95. A card-based system according to claim 50, including a security centre which is arranged to transmit a two-way communication identifier for each terminal location and each server location to a router centre to provide network interconnection and to download the communication identifiers together with encryption codes to each computer terminal and each card-type server for routing encrypted impersonal identifiers and instruction identifiers between the designated locations, and wherein security centre can communicate through the router centre for monitoring and upgrading each computer terminal at its designated location.

96. A card-based system according to claim 56, including a security centre which is arranged to transmit a two-way communication identifier for each terminal location and each server location to a router centre to provide network interconnection and to download the communication identifiers together with encryption codes to each computer terminal and each card-type server for routing encrypted impersonal identifiers and instruction identifiers between the designated locations, and wherein security centre can communicate through the router centre for monitoring and upgrading each computer terminal at its designated location.

97. A card-based system according to claim 78, including a security centre which is arranged to transmit a two-way communication identifier for each terminal location and each server location to a router centre to provide network interconnection and to download the communication identifiers together with encryption codes to each computer terminal and each card-type server for routing encrypted impersonal identifiers and instruction identifiers between the designated locations, and wherein security centre can communicate through the router centre for monitoring and upgrading each computer terminal at its designated location.

98. A card-based system according to claim 91, including a security centre which is arranged to transmit a two-way communication identifier for each terminal location and each server location to a router centre to provide network interconnection and to download the communication identifiers together with encryption codes to each computer terminal and each card-type server for routing encrypted impersonal identifiers and instruction identifiers between the designated locations, and wherein security centre can communicate through the router centre for monitoring and upgrading each computer terminal at its designated location.

99. A card-based system according to claim 93, including a security centre which is arranged to transmit a two-way communication identifier for each terminal location and each server location to a router centre to provide network interconnection and to download the communication identifiers together with encryption codes to each computer terminal and each card-type server for routing encrypted impersonal identifiers and instruction identifiers between the designated locations, and wherein security centre can communicate through the router centre for monitoring and upgrading each computer terminal at its designated location.

100. A card-based system according to claim 94, including a security centre which is arranged to transmit a two-way communication identifier for each terminal location and each server location to a router centre to provide network interconnection and to download the communication identifiers together with encryption codes to each computer terminal and each card-type server for routing encrypted impersonal identifiers and instruction identifiers between the designated locations, and wherein security centre can communicate through the router centre for monitoring and upgrading each computer terminal at its designated location.

101. A card-based system according to claim 50, wherein each set of impersonal identifiers and each set of instructions identifiers for a discrete card-type includes a two-way communication identifier for identifying the terminal location and server location, and address each set of impersonal identifiers and instruction identifiers to create a card-type record in the database of a card-type server for anonymous registration at a data centre, or to locate a card-type record in the database of the same card-type for anonymous validation at the data centre.

102. A card-based system according to claim 56, wherein each set of impersonal identifiers and each set of instructions identifiers for a discrete card-type includes a two-way communication identifier for identifying the terminal location and server location, and address each set of impersonal identifiers and instruction identifiers to create a card-type record in the database of a card-type server for anonymous registration at a data centre, or to locate a card-type record in the database of the same card-type for anonymous validation at the data centre.

103. A card-based system according to claim 78, wherein each set of impersonal identifiers and each set of instructions identifiers for a discrete card-type includes a two-way communication identifier for identifying the terminal location and server location, and address each set of impersonal identifiers and instruction identifiers to create a card-type record in the database of a card-type server for anonymous registration at a data centre, or to locate a card-type record in the database of the same card-type for anonymous validation at the data centre.

104. A card-based system according to claim 91, wherein each set of impersonal identifiers and each set of instructions identifiers for a discrete card-type includes a two-way communication identifier for identifying the terminal location and server location, and address each set of impersonal identifiers and instruction identifiers to create a card-type record in the database of a card-type server for anonymous registration at a data centre, or to locate a card-type record in the database of the same card-type for anonymous validation at the data centre.

105. A card-based system according to claim 93, wherein each set of impersonal identifiers and each set of instructions identifiers for a discrete card-type includes a two-way communication identifier for identifying the terminal location and server location, and address each set of impersonal identifiers and instruction identifiers to create a card-type record in the database of a card-type server for anonymous registration at a data centre, or to locate a card-type record in the database of the same card-type for anonymous validation at the data centre.

106. A card-based system according to claim 94, wherein each set of impersonal identifiers and each set of instructions identifiers for a discrete card-type includes a two-way communication identifier for identifying the terminal location and server location, and address each set of impersonal identifiers and instruction identifiers to create a card-type record in the database of a card-type server for anonymous registration at a data centre, or to locate a card-type record in the database of the same card-type for anonymous validation at the data centre.

107. A card-based system according to claim 50, including separate data centres to provide demarcation and anonymity for the transfer of complied data from a data centre with impersonal records to a data centre with personal records, wherein the data centre with impersonal records includes a card-type server for matching a set of impersonal identifiers in a card-type record to compile data to validate an identification or transaction at the data centre, and transfer the compiled data to the data centre of a discrete card-issuer with personal records, the compiled data is impersonal and includes a reference number and activity record for the card-issuer to enter the compiled data in a personal record with the same reference number.

108. A card-based system according to claim 56, including separate data centres to provide demarcation and anonymity for the transfer of complied data from a data centre with impersonal records to a data centre with personal records, wherein the data centre with impersonal records includes a card-type server for matching a set of impersonal identifiers in a card-type record to compile data to validate an identification or transaction at the data centre, and transfer the compiled data to the data centre of a discrete card-issuer with personal records, the compiled data is impersonal and includes a reference number and activity record for the card-issuer to enter the compiled data in a personal record with the same reference number.

109. A card-based system according to claim 78, including separate data centres to provide demarcation and anonymity for the transfer of complied data from a data centre with impersonal records to a data centre with personal records, wherein the data centre with impersonal records includes a card-type server for matching a set of impersonal identifiers in a card-type record to compile data to validate an identification or transaction at the data centre, and transfer the compiled data to the data centre of a discrete card-issuer with personal records, the compiled data is impersonal and includes a reference number and activity record for the card-issuer to enter the compiled data in a personal record with the same reference number.

110. A card-based system according to claim 91, including separate data centres to provide demarcation and anonymity for the transfer of complied data from a data centre with impersonal records to a data centre with personal records, wherein the data centre with impersonal records includes a card-type server for matching a set of impersonal identifiers in a card-type record to compile data to validate an identification or transaction at the data centre, and transfer the compiled data to the data centre of a discrete card-issuer with personal records, the compiled data is impersonal and includes a reference number and activity record for the card-issuer to enter the compiled data in a personal record with the same reference number.

111. A card-based system according to claim 93, including separate data centres to provide demarcation and anonymity for the transfer of complied data from a data centre with impersonal records to a data centre with personal records, wherein the data centre with impersonal records includes a card-type server for matching a set of impersonal identifiers in a card-type record to compile data to validate an identification or transaction at the data centre, and transfer the compiled data to the data centre of a discrete card-issuer with personal records, the compiled data is impersonal and includes a reference number and activity record for the cardissuer to enter the compiled data in a personal record with the same reference number.

112. A card-based system according to claim 94, including separate data centres to provide demarcation and anonymity for the transfer of complied data from a data centre with impersonal records to a data centre with personal records, wherein the data centre with impersonal records includes a card-type server for matching a set of impersonal identifiers in a card-type record to compile data to validate an identification or transaction at the data centre, and transfer the compiled data to the data centre of a discrete card-issuer with personal records, the compiled data is impersonal and includes a reference number and activity record for the card-issuer to enter the compiled data in a personal record with the same reference number.

113. A card-based system according to claim 50, wherein an attendant inserts an unissued card in the receiving and identifying means, said computing means originates an impersonal card-identifier, the user operates said input means to input selected characters known only to the user, said computing means processes the input characters to originate an impersonal user-identifier and said terminal transmits said impersonal identifiers to said database for recording an original set of impersonal identifiers therein.

114. A card-based system according to claim 113, wherein said terminal receives instruction identifiers from the database to accept or reject the impersonal identifiers and instruct the attendant to remove the card from said terminal to keep an invalid card or hand a valid card to the user.

115. A card-based system according to claim 56, wherein an attendant inserts an issued card in the receiving means, and identifying said computer means generates the impersonal card-identifier, the user operates said input means to input selected characters known only to the user, said computing means processes the input characters to originate an impersonal user-identifier, and said terminal transmits said impersonal identifiers to said database for matching a duplicate set of impersonal identifiers therein.

116. A card-based system according to claim 113, wherein a duplicate set of impersonal identifiers are compared with an original set of impersonal identifiers in the same database of a card-type server.

117. A card-based system according to claim 113, wherein the impersonal identifiers and instruction identifier are solely in numeric form.

118. A card-based system for impersonal cards, wherein the card is constructed of laminate material comprising two outer layers bonded to a middle layer for concealing an integrated circuit and aerial within the middle layer for writing and reading data in the receiving and identifying means.

119. A card-based system according to claim 118 wherein the middle layer comprises a material with inductance and or capacitance properties to supply an electric charge to power the integrated circuit when the card is inserted in the receiving and identifying means.

120. A card-based system according to claim 119 wherein the laminate material includes a printed overlay film on the outer surface of each outer layer to display machine printed information for different card-types.

121. A card-based system according to claim 119, wherein the laminate material includes a thermal layer affixed thereto for terminal printing thermal images and characters in defined areas for different card-types.

122. A card-based system according to claim 121, wherein the thermal layer includes a passive circuit on the underside to detect the said circuit when a card-type is inserted in the receiving and identifying means.
